(19) United States
(12) Patent Application Publication
(10) Pub. No.: US 2013/0212181 A1
(43) Pub. Date: Aug. 15, 2013

(54) INFORMATION-PROCESSING DEVICE, COMMENT-PROMPTING METHOD, AND COMPUTER-READABLE RECORDING MEDIUM

(71) Applicants: Taku Konishi, Tokyo (JP); Daishi Kato, Tokyo (JP); Shinichi Doi, Tokyo (JP)

(72) Inventors: Taku Konishi, Tokyo (JP); Daishi Kato, Tokyo (JP); Shinichi Doi, Tokyo (JP)

(73) Assignee: NEC CORPORATION, Minato-ku, Tokyo (JP)

(21) Appl. No.: 13/880,771

(22) PCT Filed: Aug. 15, 2011
(86) PCT No.: PCT/JP2011/068511

§ 371 Date: Apr. 22, 2013

(30) Foreign Application Priority Data
Oct. 25, 2010 (JP) 2010-238243

(51) Int. Cl. H04L 29/08

(52) U.S. Cl. CPC H04L 67/22
USPC 709/204

(57) ABSTRACT

An information-processing device (201), comprises: a user information acquisition part (3) configured to acquire user information indicating at least one of an attribute of a subject user, said subject user's content of opinion with respect to one or more evaluation subjects, and said subject user's operation history;
a group determination part (4) configured to determine a group to which said subject user belongs from among a plurality of groups based on user information acquired by said user information acquisition part (3); and
an input-prompting part (5) configured to present, to said subject user based on said group to which said subject user belongs, prompting information for inducing said subject user to input a new evaluation subject or content of opinion with respect to a presented evaluation subject which is an evaluation subject presented to said subject user.

### TECHNICAL FIELD

The present invention relates to an information-processing device, a comment-prompting method, and a computer readable recording medium, and in particular, relates to an information-processing device, comment-prompting method and computer readable recording medium for the purpose of prompting a user to input content of opinion with respect to an evaluation subject by presenting some sort of information to the user.

### BACKGROUND ART

Recent years, owing to dramatic progress of information communication environment such as Internet and a mobile phone, it has been possible to perform opinion-issuing widely without being subject to temporal and geographical constraints. For example, an opinion-issuing means such as Web vote and comment input on a homepage has propagated.

Then, in order to make an occasion for opinion-issuing like this prosperous, a system capable of acquiring an opinion from a larger number of people is expected.

As an example of a system which collects opinions from users, for example, in Japanese Patent Laid-Open No. 2006-293518 (Patent document 1), the following system has been disclosed. That is, a vote posting system comprises: an item list accumulation part storing an item list where items to be collected through voting are determined; a first information disclosure part configured to create a data-inputting screen having items of which selective input is possible and a posting column where descriptive input of arbitrary characters is possible based on the above-mentioned item list acquired from this item list accumulation part; an interface part configured to make the above-mentioned data-inputting screen displayed on a voter terminal via an electronic network, and at the same time, accept the data inputted on the above-mentioned data-inputting screen by the above-mentioned voter terminal; a storage part configured to store the accepted data; and an information analysis part configured to carry out grouping, for each item, of the data stored in this storage part.

### PRIOR ART DOCUMENT

### Patent Document

Patent Document 1: Japanese Patent Laid-Open No. 2006-293518

### SUMMARY OF THE INVENTION

### Problems to be Solved by the Invention

Meanwhile, for example, in many cases in a system for the purpose of collecting opinions with respect to a certain content, a few users input a comment positively with respect to this content among users who browse this content, and most users only browse this content and does not input comments. Consequently, a scheme capable of inducing a large number of users' comments is expected.

However, a configuration for the purpose of solving the problem such as this is not disclosed in Patent document 1.

This invention has been accomplished for solving the above-mentioned problem, and the object is to provide an information-processing device, comment-prompting method and computer readable recording medium which are capable of collecting opinions from a larger number of users.

### Means for Solving the Problems

For solving the problems mentioned above, an information-processing device according to an aspect of the present invention, comprising: a user information acquisition part configured to acquire user information indicating at least one of an attribute of a subject user, said subject user's content of opinion with respect to one or more evaluation subjects, and said subject user's operation history; a group determination part configured to determine a group to which said subject user belongs from among a plurality of groups based on user information acquired by said user information acquisition part; and an input-prompting part configured to present, to said subject user based on said group to which said subject user belongs, prompting information for inducing said subject user to input a new evaluation subject or content of opinion with respect to a presented evaluation subject which is an evaluation subject presented to said subject user.

For solving the problems mentioned above, a comment-prompting method according to an aspect of the present invention, comprising: a step to acquire user information indicating at least one of an attribute of a subject user, said subject user's content of opinion with respect to one or more evaluation subjects, and said subject user's operation history; a step to determine a group to which said subject user belongs from among a plurality of groups based on said user information; and a step to present, to said subject user, based on said group to which said subject user belongs, prompting information for inducing said subject user to input a new evaluation subject or content of opinion with respect to a presented evaluation subject which is an evaluation subject presented to said subject user.

For solving the problems mentioned above, a computer readable recording medium in which recorded is a comment-prompting program to make a computer execute: a step to acquire user information indicating at least one of an attribute of a subject user, said subject user's content of opinion with respect to one or more evaluation subjects, and said subject user's operation history; a step to determine a group to which said subject user belongs from among a plurality of groups based on said user information; and a step to present, to said subject user, based on said group to which said subject user belongs, prompting information for inducing said subject user to input a new evaluation subject or content of opinion with respect to a presented evaluation subject which is an evaluation subject presented to said subject user.

### Effect of the Invention

According to the present invention, opinions from a larger number of users can be collected.

### BRIEF DESCRIPTION OF THE DRAWINGS

FIG. 1 is a schematic configuration diagram of an information-processing device according to the first embodiment of the present invention;

FIG. 2 is a block diagram showing a control structure which an information-processing device according to the first embodiment of the present invention provides;

FIG. 3 is a figure showing an example of each phase until comment input or article input in the information-processing device according to the first embodiment of the present invention;

FIG. 4 is a figure showing an example of classification information in the information-processing device according to the first embodiment of the present invention;

FIG. 5 is a figure showing an example of a message determination table in the information-processing device according to the first embodiment of the present invention;

FIG. 6 is a flow chart indicating an operation procedure in the case where the information-processing device according to the first embodiment of the present invention performs comment-prompting processing;

FIG. 7 is a figure showing an example of a display screen with respect to a user in the case where the information-processing device according to the first embodiment of the present invention performs comment-prompting processing;

FIG. 8 is a figure showing other example of a display screen with respect to a user in the case where the information-processing device according to the first embodiment of the present invention performs comment-prompting processing;

FIG. 9 is a figure showing other example of a display screen with respect to a user in the case where the information-processing device according to the first embodiment of the present invention performs comment-prompting processing;

FIG. 10 is a figure showing other example of classification information in the information-processing device according to the first embodiment of the present invention;

FIG. 11 is a flow chart showing an operation procedure in the case where the information-processing device according to the second embodiment of the present invention performing comment-prompting processing;

FIG. 12 is a flow chart showing an operation procedure in the case where the information-processing device according to the second embodiment of the present invention performs comment-prompting processing;

FIG. 13 is a figure showing a frequency distribution of standby time until comment input with respect to an evaluation subject;

FIG. 14 is a figure showing a frequency distribution of standby time until comment input of each user who has browsed a certain article;

FIG. 15 is a figure showing a frequency distribution of standby time until comment input of each user who has browsed a certain article;

FIG. 16 is a figure showing standby time and a standby time type with respect to each article of the subject user;

FIG. 17, with respect to each user who has browsed an article X, is a figure showing a frequency distribution of standby time until comment input and a presenting timing of prompting information with respect to a subject user;

FIG. 18 is a figure showing an example of a user table in the information-processing device according to the fourth embodiment of the present invention;

### BEST MODES FOR CARRYING OUT THE INVENTION

Hereinafter, an embodiment of the present invention will be described using the figures. It is noted that the same reference character will be given to the same or corresponding part in the figures, and thus the description will not be repeated.

### First Embodiment

The information-processing device according to the first embodiment of the present invention, typically, includes a computer which has a general-purpose architecture as a basic structure, and provides various functions described later by executing a program installed in advance. Generally, a program like this circulates in a state of being stored in a recording medium such as a flexible disk (Flexible Disk) and a CD-ROM (Compact Disk Read Only Memory), or via a network, etc. In the case where a general-purpose computer like this is used, in addition to an application for providing functions according to the first embodiment of the present invention, an OS (Operating System) for providing a fundamental function of the computer may be installed. In this case, a program according to the first embodiment of the present invention may be what executes processing by calling a required module in a prescribed order and/or timing within program modules provided as a part of the OS. That is, a program itself according to the first embodiment of the present invention may not include above modules, and processing may be executed by collaborating with the OS. Therefore, as a program according to the first embodiment of the present invention, it may have a configuration which does not include modules as mentioned above.

Furthermore, a program according to the first embodiment of the present invention may be provided with being incorporated in a part of other programs such as an OS. Also in this case, a program itself according to the first embodiment of the present invention does not include modules which other programs of the incorporation destination have as mentioned above, and the processing is executed by collaborating with the other programs. That is, as a program according to the first embodiment of the present invention, it may have a configuration which is incorporated in other programs like this.

Besides, alternatively, apart or all of functions which are provided by the program execution may be implemented as dedicated hardware circuitry.

[Apparatus Configuration]

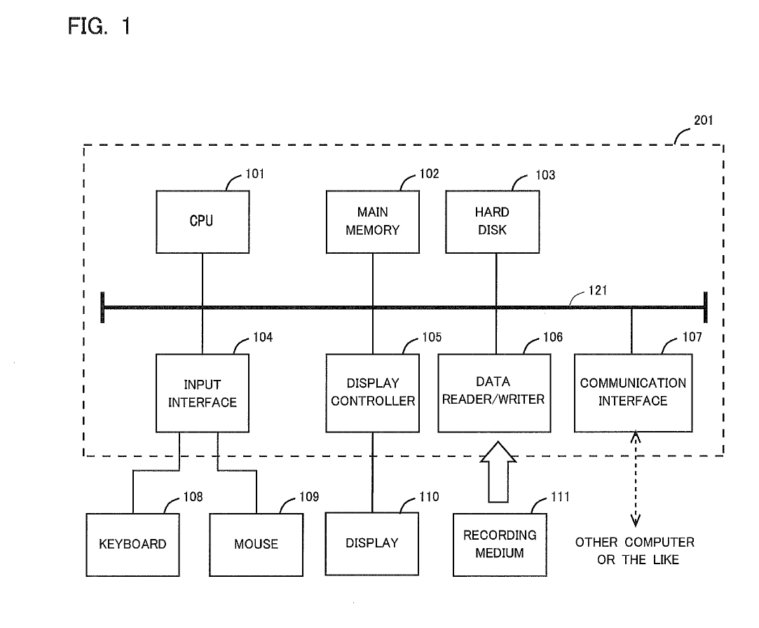

FIG. 1 is a schematic configuration diagram of an information-processing device according to the first embodiment of the present invention. With reference to FIG. 1, a information-processing device 201 is an information processing apparatus such as a portable information terminal, a personal computer and a server, and comprises: a CPU(Central Processing Unit) 101 which is an arithmetic processing unit; a main memory 102 and a hard disk 103; an input interface 104; a display controller 105; a data reader/writer 106; and a communication interface 107. Each of these parts is connected in a manner where data communication is possible mutually via a bus 121.

The CPU101 carried out various calculations by reading out programs (code) stored in the hard disk 103 and writing to the main memory 102, and executing these in prescribed order.

The main memory 102 typically is a volatile storage device such as a DRAM (Dynamic Random Access Memory), and holds data etc. which indicate various arithmetic processing results in addition to programs read from the hard disk 103. The hard disk 103 is nonvolatile magnetic storage device, and various setting values etc. are stored in addition to the programs executed by the CPU101. Programs installed on this hard disk 103 circulate in a state of being stored in a recording medium 111 as described later. Besides, in addition to the hard disk 103, or in place of the hard disk 103, a semiconductor memory such as a flash memory may be adopted.

The input interface 104 intermediates data transmission between the CPU101 and a keyboard 108, a mouse 109 and an input unit such as a touch panel which is not illustrated. That is, the input interface 104 accepts an input from the outside, such as operation command given by a user operating the input unit.

The display controller 105 is connected with a display 110 which is a typical example of a display unit, and controls display on the display 110. That is, the display controller 105 displays to a user a result or the like of image processing by the CPU101. The display 110 is a LCD (Liquid Crystal Display) or a CRT (Cathode Ray Tube), for example.

The data reader/writer 106 intermediates data transmission between the CPU101 and the recording medium 111. That is, the recording medium 111 circulates in a state where programs etc. executed by the information-processing device 201 is stored, and the data reader/writer 106 reads the programs from this recording medium 111.

The data reader/writer 106, in response to an internal command of the CPU101, writes a processing result, etc. in the information-processing device 201 to the recording medium 111. Besides, the recording medium 111 is, for example, a general-purpose semiconductor storage device such as a CF (Compact Flash) and a SD (Secure Digital), a magnetic storage medium such as a flexible disk (Flexible Disk), or an optical storage medium such as a CD-ROM (Compact Disk Read Only Memory).

The communication interface 107 intermediates data transmission between the CPU101 and a personal computer, a server device or the like. The communication interface 107, typically, has a communication function of Ethernet® or a USB (Universal Serial Bus). Besides, in place of a configuration where programs stored in the recording medium 111 are installed on the information-processing device 201, programs downloaded from a distribution server etc. via the communication interface 107 may be installed on the information-processing device 201.

To the information-processing device 201, other output apparatuses, such as a printer, may be connected as necessary.

[Control Structure]

Then, a control structure for providing various functions in an information-processing device 201 according to the first embodiment of the present invention will be described.

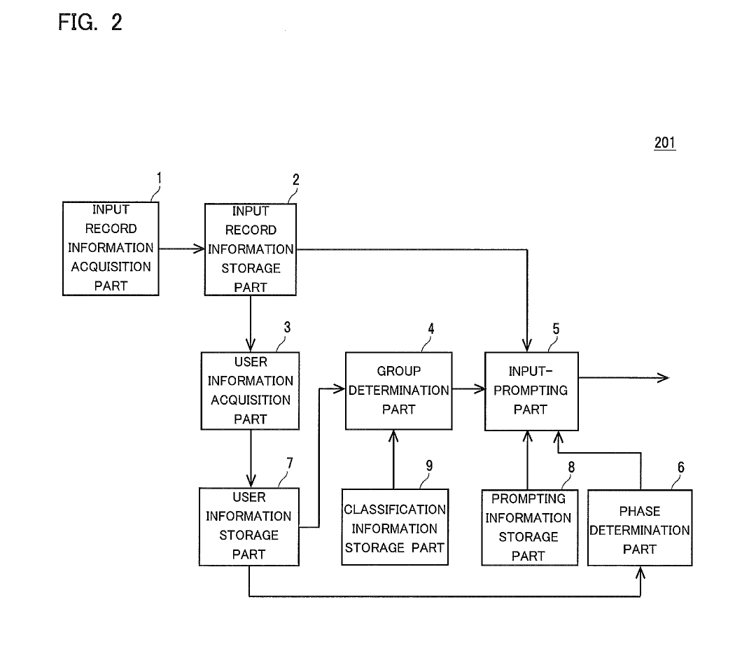

FIG. 2 is a block diagram showing a control structure which an information-processing device according to the first embodiment of the present invention provides.

Each block of the information-processing device 201 shown in FIG. 2 is provided by reading out programs (code) etc. stored in the hard disk 103 and writing to the main memory 102, and making the CPU101 execute them. Besides, a part or all of modules shown in FIG. 2 may be provided by a firmware implemented in hardware. Alternatively, a part or all of control structures shown in FIG. 2 may be realized by dedicated hardware and/or a wiring circuit.

The information-processing device 201, for example, in the case where there exists a community where a user makes a comment to each other with respect to a theme “Let's think about the future”, and there exist a plurality of articles with respect to this theme, presents after-mentioned prompting information to a user participating in this community.

With reference to FIG. 2, the information-processing device 201, as a control structure thereof, comprises: an input record information acquisition part 1; an input record information storage part 2; a user information acquisition part 3; a group determination part 4; an input-prompting part 5; a phase determination part 6; a user information storage part 7; a prompting information storage part 8; and a classification information storage part 9. The input record information storage part 2, user information storage part 7, prompting information storage part 8 and classification information storage part 9 correspond to the main memory 102 or hard disk 103 shown in FIG. 1, for example. The input-prompting part 5 outputs prompting information to the hard disk 103 or display 110 shown in FIG. 1, for example.

CPU101 is generally constituted of many units other than each part shown in FIG. 2, and however, other units are not illustrated for simplicity of description.

The user information acquisition part 3 acquires user information indicating at least either of a subject user's content of opinion e.g. a comment with respect to one or more evaluation subjects and/or a subject user's operation history with respect to one or more evaluation subjects. Besides, the subject user's operation history may be an operation history with respect to the information-processing device 201, or may be an operation history with respect to other devices.

Here, the evaluation subject means all the matters which can be subjects of opinion-issuing. For example, in evaluation subjects, included are an agenda such as a policy, a measure, law, a bill, a rule, an incident, and a news article; a good such as food and a product; service such as service in stores, service in facilities, and service of Web contents; a copyrighted work such as literature, music, a picture, a sculpture, a movie, a theater, and a building; and an opinion and idea of others.

The group determination part 4, based on the user information acquired by the user information acquisition part 3, determines a group to which the subject user belongs from among a plurality of groups.

The input-prompting part 5, based on the group to which the subject user belongs, presents to the subject user prompting information, for example, a message for the purpose of inducing the subject user to input a new evaluation subject or content of opinion with respect to a presented evaluation subject which is an evaluation subject presented to the subject user. For example, the input-prompting part 5 determines a prompting information content for every group.

Specifically, the prompting information storage part 8 stores a correspondence relation between each group and a prescribed message which is prompting information. Then, the input-prompting part 5, from among messages stored in the prompting information storage part 8, selects as prompting information a message corresponding to the group to which the subject user belongs.

In addition, for example, in the information-processing device 201, an operation until a subject user inputs a new evaluation subject or content of opinion with respect to a presented evaluation subject is classified into a plurality of stages (phases).

The user information acquisition part 3 acquires user information indicating a subject user's operation history in each phase.

The group determination part 4, based on the operation history indicated by the user information acquired by the user information acquisition part 3, determines a group to which the subject user belongs from among a plurality of groups.

In addition, the input-prompting part 5, for every phase, based on a group to which the subject user belongs, presents prompting information for the purpose of inducing the subject user to the next phase.

In more details, the group determination part 4, based on the subject user's operation history in one or more phases to which the subject user has moved before a subject phase, determines a group to which the subject user belongs from among a plurality of groups.

The input-prompting part 5, in the subject phase or a phase to which the subject user moves after the subject phase, presents prompting information to the subject user based on the group to which the subject user belongs.

The phase determination part 6, based on a subject user's operation history, determines a subject user's current phase.

The input-prompting part 5, based on a determination result by the phase determination part 6, presents prompting information for every phase.

[Operation]

Then, an operation of a information-processing device according to the first embodiment of the present invention will be described using the figures In the first embodiment of the present invention, a comment-prompting method according to a first embodiment of the present invention is performed by making the information-processing device 201 operate. Therefore, a description of the comment-prompting method according to the first embodiment of the present invention is substituted by an operation description of the following information-processing device 201. In the following description, FIG. 1 is referred to suitably.

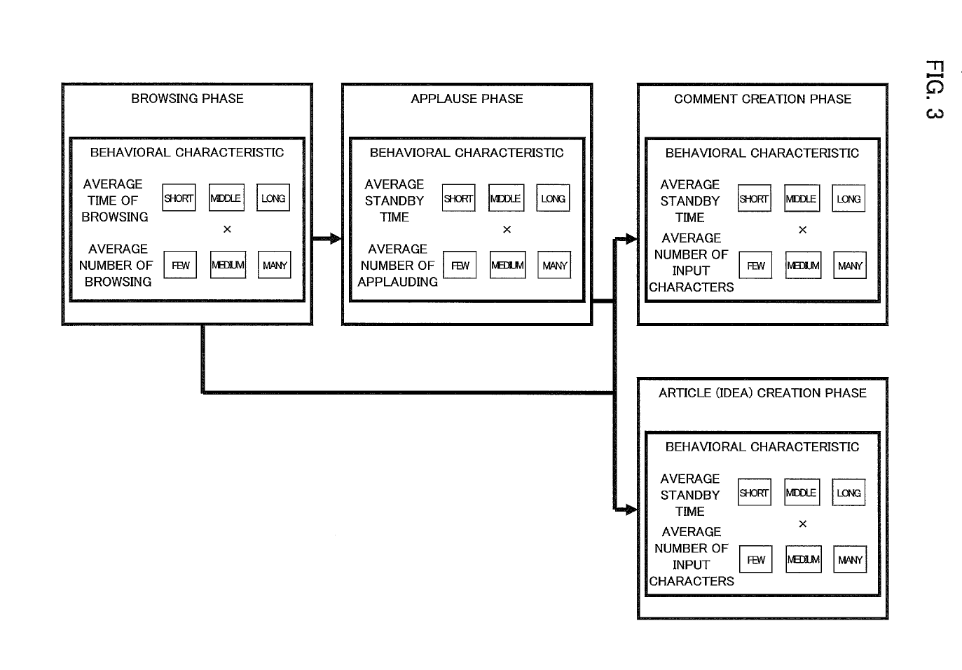

FIG. 3 is a figure showing an example of each phase until comment input or article input in the information-processing device according to the first embodiment of the present invention.

With reference to FIG. 3, in the information-processing device 201, as a criterion of type-classifying of a user, i.e., group classification, for example, a user's behavioral characteristic in each phase is used.

That is, in the information-processing device 201, for example, configured are phases that are: a phase in which a subject user browses a presented evaluation subject; a phase in which a subject user evaluates a presented evaluation subject; a phase in which a subject user inputs content of opinion with respect to a presented evaluation subject; and a phase in which a subject user inputs a new evaluation subject.

Specifically, in the information-processing device 201, a browsing phase, an applause phase (evaluation phase), and a new creation phase are provided. The new creation phase includes a comment creation phase and an article (idea) creation phase.

In the information-processing device 201, the user's behavioral characteristic in each phase is represented by a combination of parameters.

That is, in the information-processing device 201, as a behavioral characteristic in the browsing phase, for example, average time of browsing and the average number of browsing are used. In addition, as a behavioral characteristic in the applause phase, for example, average standby time and the average number of applauding are used. In addition, as a behavioral characteristic in a comment creation phase, for example, average standby time and the average number of input characters are used. In addition, as a behavioral characteristic in an article creation phase, for example, average standby time and the average number of input characters are used.

Specifically, in the browsing phase, the group determination part 4 determines whether a user has a tendency of looking at an evaluation subject only in a short time, or a user has a tendency of looking at it deliberately. In addition, the group determination part 4 determines whether a user has a tendency of looking at only a few evaluation subjects, or a user has a tendency of looking at many evaluation subjects.

In addition, in the applause phase, the group determination part 4 determines whether a user has a tendency of applauding in a short time after having browsed an evaluation subject, or a user has a tendency of applauding after a long time after having browsed an evaluation subject. In addition, the group determination part 4 determines whether a user has a tendency of applauding a few times or a user has a tendency of applauding many times.

In addition, in the comment creation phase, the group determination part 4 determines whether a user has a tendency of inputting a comment in a short time after having browsed an evaluation subject or a user has a tendency of inputting a comment in a long time after having browsed an evaluation subject. In addition, the group determination part 4 determines whether a user has a tendency of inputting a short comment or a user has a tendency of inputting a long comment.

In addition, in the article creation phase, the group determination part 4 determines whether a user has a tendency of inputting an article in a short time after having browsed an evaluation subject or a user has a tendency of inputting an article in a long time after having browsed an evaluation subject. In addition, the group determination part 4 determines whether a user has a tendency of inputting a short article, or a user has a tendency of inputting a long article.

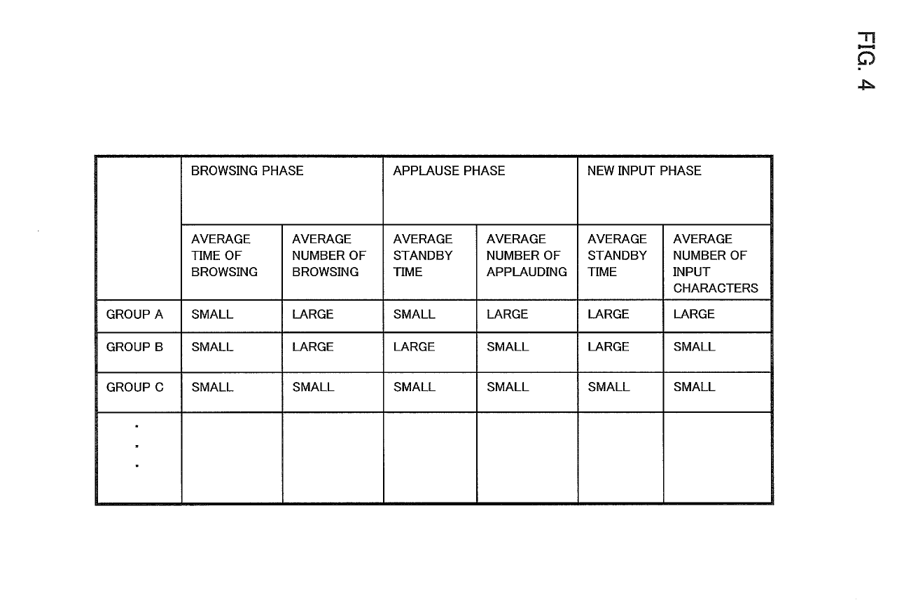

FIG. 4 is a figure showing an example of classification information in the information-processing device according to the first embodiment of the present invention.

With reference to FIG. 4, the classification information storage part 9 stores a group-behavioral characteristic table which is classification information indicating a plurality of groups classified based on each user's behavioral characteristic in each phase. That is, the classification information storage part 9 stores classification information indicating a plurality of groups classified based on a user's content of opinion with respect to an evaluation subject and a user's operation history with respect to the evaluation subject.

The group determination part 4, based on the user information acquired by the user information acquisition part 3, determines a group to which a subject user belongs from among a plurality of groups indicated by classification information stored by the classification information storage part 9

Specifically, in this group-behavioral characteristic table, for example, average time of browsing in a browsing phase of a user belonging to group A is a “small” level and an average number of browsing is a “large” level, and average standby time in the applause phase is a “small” level and the average number of applauding is a “large” level, and average standby time in the new input phase is a “large” level, and the average number of input characters is a “large” level. That is, as a behavioral pattern of a user belonging to group A, a tendency of browsing many articles one after another in a short time, a tendency of inputting many applauses immediately after having browsed articles, and a tendency of inputting a long comment or article in a long time after having browsed articles are acquired as a part of classification information.

In addition, with respect to a user belonging to group B, average time of browsing in the browsing phase is a “small” level and the average number of browsing is a “large” level, and average standby time in the applause phase is a “large” level and the average number of applauding is a “small” level, and average standby time in the new input phase is a “large” level and the average number of input characters is a “small” level.

In addition, with respect to a user belonging to group C, the average time of browsing in the browsing phase is a “small” level and average number of browsing is a “small” level, and the average standby time in the applause phase is a “small” level and the average number of applauding is a “small” level, and the average standby time in the new input phase is a “small” level and the average number of input characters is a “small” level.

Besides, each group's behavioral characteristic in this group-behavioral characteristic table may be acquired from a behavioral characteristic of one user, and may be acquired from behavioral characteristics of a plurality of users.

For example, in the information-processing device 201, as a user's operation history, acquired are the number of input characters of a user's past comment, and standby time after a user has finished browsing of an evaluation subject and has moved to the comment creation phase until inputting a comment. Then, users are classified based on a combination between them, and a message to be presented to a user based on the classification results is determined.

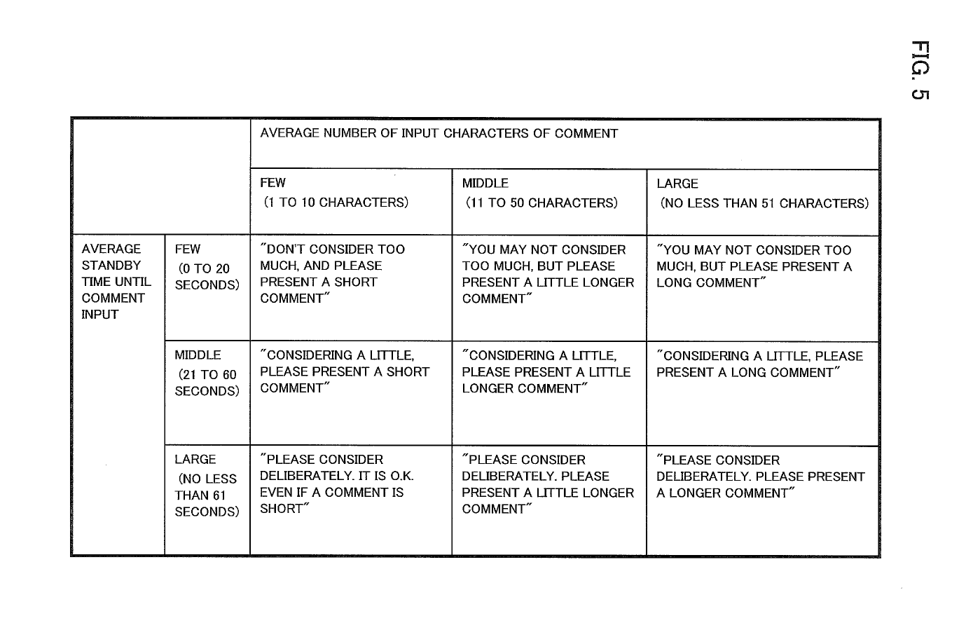

FIG. 5 is a figure showing an example of a message determination table in the information-processing device according to the first embodiment of the present invention.

With reference to FIG. 5, this message determination table indicates each message presented in the comment creation phase, and is a table indicating the average number of input characters of past comments by a user, average standby time until comment input, and a message content corresponding to a combination between them.

In this message determination table, the average number of input characters of a comment is level-classified into “large”, “middle” and “small”, and average standby time until comment input is level-classified into “large”, “middle” and “small”, and nine types of messages corresponding to combinations of each level are indicated. That is, this message determination table indicates nine messages which correspond each to nine classified user groups.

For example, a case where the average number of input characters of a comment is one character to ten characters corresponds to a “small” level, and a case where the average number of input characters of a comment is 11 characters to 50 characters corresponds to a “middle” level, and a case where the average number of input characters of a comment is no less than 51 characters corresponds to a “large” level. In addition, a case where average standby time until comment input is 0 second to 20 seconds corresponds to a “small” level, and a case where average standby time until comment input is 21 seconds to 60 seconds corresponds to a “middle” level, and a case where average standby time until comment input is no less than 61 seconds corresponds to a “large” level.

Then, a message to be presented to a user where average standby time is a “small” level and average number of input characters is a “small” level is “Don't consider too much, and please present a short comment”, and a message to be presented to a user where average standby time is a “small” level and average number of input characters is a “middle” level is “You may not consider too much, but please present a little longer comment”, and a message to be presented to a user where average standby time is a “small” level and average number of input characters is a “large” level is “You may not consider too much, but please present a long comment”.

In addition, a message to be presented to a user where average standby time is a “middle” level and average number of input characters is a “small” level is “considering a little, please present a short comment”, and a message to be presented to a user where average standby time is a “middle” level and average number of input characters is a “middle” level is “considering a little, please present a little longer comment”, and a message to be presented to a user where average standby time is a “middle” level and average number of input characters is a “large” level is “Considering a little, please present a long comment”.

In addition, a message to be presented to a user where average standby time is a “large” level and average number of input characters is a “small” level is “Please consider deliberately. It is O.K. even if a comment is short.”, and a message to be presented to a user where average standby time is a “large” level and average number of input characters is a “middle” level is “Please consider deliberately. Please present a little longer comment.”, and a message to be presented to a user where average standby time is a “large” level and average number of input characters is a “large” level is “Please consider deliberately. Please present a longer comment”.

The prompting information storage part 8 stores this message determination table. The input-prompting part 5, with reference to the message determination table stored in the prompting information storage part 8, selects a message corresponding to a group to which a subject user belongs.

Specifically, the input-prompting part 5, in the case where with respect to a subject user to which prompting information is to be presented, i.e., a user who is browsing an evaluation subject indicated by the information-processing device 201 and has not yet inputted a comment, average standby time is 30 seconds and the past average number of input characters are 40 characters, presents “Considering a little, please present a little longer comment” which is a message where average standby time is a “middle” level and the average number of input characters is a “middle” level.

Besides, a subject of an operation history in this message determination table may be both an evaluation subject which a subject user is browsing and other evaluation subject, and may be either of a presented evaluation subject which a subject user is browsing and/or an evaluation subject of other.

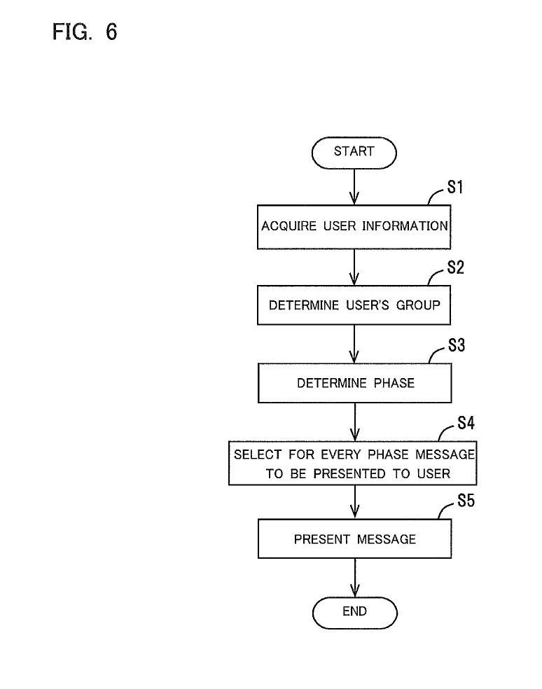

FIG. 6 is a flow chart indicating an operation procedure in the case where the information-processing device according to the first embodiment of the present invention performs comment-prompting processing.

With reference to FIG. 6, first, when a user starts browsing of an evaluation subject, the user information acquisition part 3 acquires user information indicating an operation history or the like of a subject user who is the user having started browsing of the evaluation subject (Step S1).

Next, the group determination part 4, with reference to the group-behavioral characteristic table stored in the classification information storage part 9, based on the user information acquired by the user information acquisition part 3, determines a group to which the subject user belongs (Step S2).

Next, the phase determination part 6, based on the subject user's operation history, determines the subject user's current phase (Step S3).

Next, the input-prompting part 5, with reference to the message determination table stored in the prompting information storage part 8, based on a determination result by the group determination part 4 and a determination result by the phase determination part 6, selects a message corresponding to the group to which the subject user belongs and to the subject user's current phase (Step S4).

Then, the input-prompting part 5 presents the selected message to the subject user by displaying it on a screen or the like (Step S5).

When description is carried out using a specific example, the user information acquisition part 3 acquires as user information an operation history which indicates that a user X browsing each article which is an evaluation subject has browsed many articles one after another in a short time in a browsing phase, and has inputted a number of applauses immediately after the article browsing in an applause phase, and stores it in the user information storage part 7 (Step S1).

Next, the group determination part 4, based on the user information stored in the user information storage part 7, determines that a browsing behavior, i.e., behavior in a browsing phase and an applause behavior, i.e., behavior in an applause phase, which are performed by a user X, are behavioral patterns similar to those of the group A in a group-behavioral characteristic table shown in FIG. 4 stored in the classification information storage part 9 (Step S2).

Next, the phase determination part 6, based on the user X's operation history indicated by the user information stored in the user information storage part 7, determines that the user X's current phase is the comment creation phase (Step S3).

Next, the input-prompting part 5, in the comment creation phase, with reference to the message determination table shown in FIG. 5 stored in the prompting information storage part 8, selects a message, corresponding to group A, where average standby time is a “large” level, and the average number of input characters is a “large” level (Step S4), and presents it to the user X (Step S5).

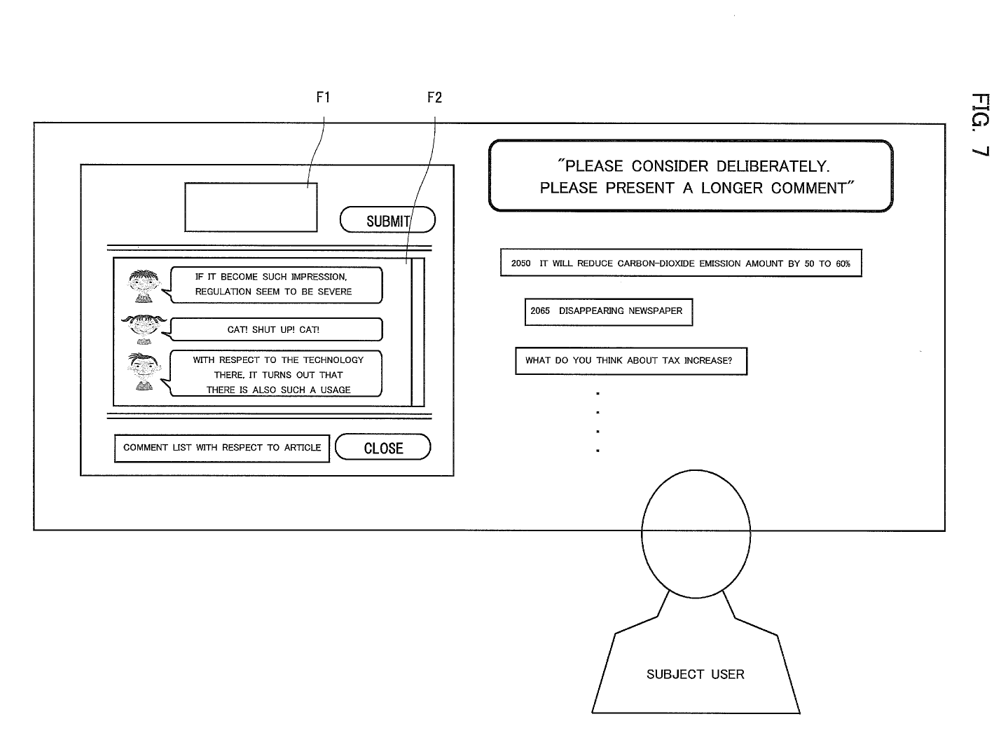

FIG. 7 is a figure showing an example of a display screen with respect to a user in the case where the information-processing device according to the first embodiment of the present invention performs comment-prompting processing.

With reference to FIG. 7, in the comment creation phase, an input field F1 for the purpose of a user inputting a comment and a comment field F2 where each user's comment is arranged are displayed on a screen. A scroll bar is provided, for example, in the past comment field F2, and a user can browse each comment.

The input-prompting information presenting part 5, for example, displays on a screen a message, corresponding to group A, where average standby time is a “large” level, and the average number of input characters is a “large” level, i.e., the message “Please consider deliberately. Please present a longer comment”.

By such a message as this, user X's comment input with respect to an evaluation subject is prompted, and the user X inputs a comment.

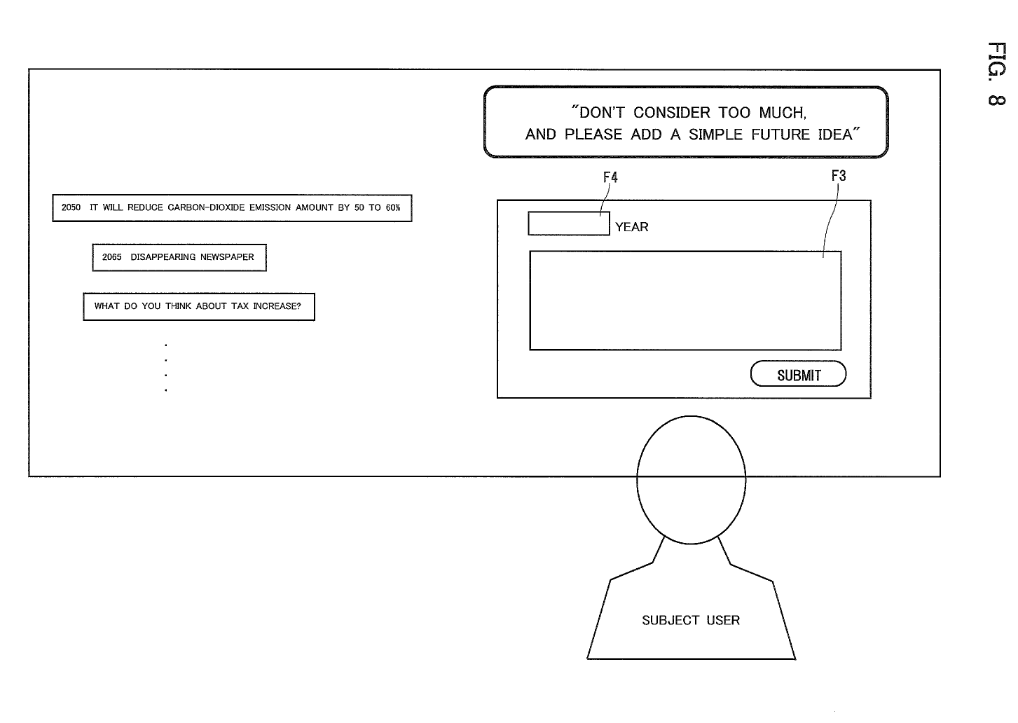

FIG. 8 is a figure showing other example of a display screen with respect to a user in the case where the information-processing device according to the first embodiment of the present invention performs comment-prompting processing.

With reference to FIG. 8, in the article creation phase, an input field F3 for the purpose of a user inputting an idea with respect to the future, and an input field F4 for the purpose of inputting the year where this idea will be realized are displayed on a screen.

The input-prompting information presenting part 5, for example, displays on a screen the message “Don't consider too much, and Please add a simple future idea”.

By such a message as this, a user X's new article input is prompted, and the user X inputs a new article.

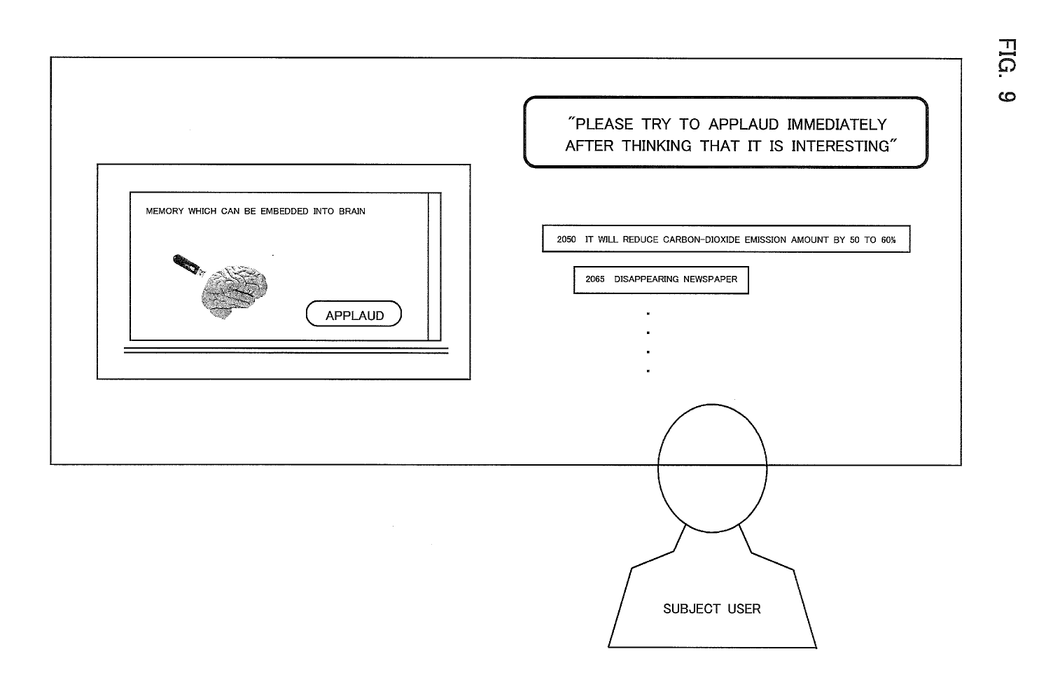

FIG. 9 is a figure showing other example of a display screen with respect to a user in the case where the information-processing device according to the first embodiment of the present invention performs comment-prompting processing.

With reference to FIG. 9, in the applause phase, the input-prompting information presenting part 5, for example, displays on a screen the message “Please try to applaud immediately after thinking that it is interesting”.

Looking at such a message as this, a user X performs applause input with respect to an evaluation subject, and is induced to a next phase, for example, a new input phase.

In addition, the information-processing device 201, as a criterion of type-classifying of a user, i.e., group classification may be configured to use a move characteristic of each behavior phase by a user, for example.

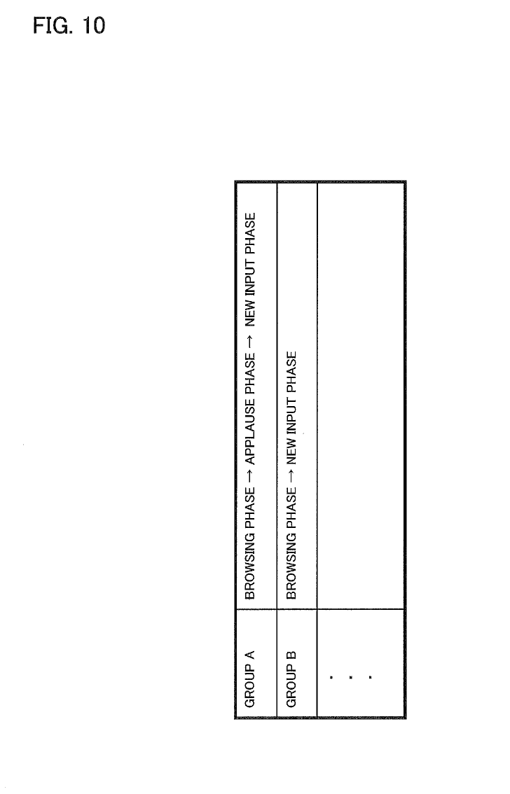

FIG. 10 is a figure showing other example of classification information in the information-processing device according to the first embodiment of the present invention.

With reference to FIG. 10, the classification information storage part 9 stores a group-behavioral characteristic table which is classification information indicating a plurality of groups classified based on a moving pattern between phases of each user. That is, the classification information storage part 9 stores classification information indicating a plurality of groups classified based on a user's operation history with respect to an evaluation subject.

In this group-behavioral characteristic table, for example, a moving pattern of a user belonging to group A is a pattern where a user moves from a browsing phase to an applause phase, and moves from an applause phase to a new input phase.

In addition, a moving pattern of a user belonging to group B is a pattern where a user moves from a browsing phase to a new input phase. That is, acquired is as apart of classification information a tendency where a user skips an applause phase as a moving pattern of the user belonging to group B and moves directly to a new input phase from a browsing phase.

The user information acquisition part 3 acquires user information indicating a phase move history by a subject user.

The group determination part 4, based on the move history indicated by the user information acquired by the user information acquisition part 3, determines a group to which the subject user belongs from among a plurality of groups.

In more details, the group determination part 4, based on the phase move history by the subject user to the subject phase, determines a group to which the subject user belongs from among a plurality of groups.

Specifically, again with reference to FIG. 6, the user information acquisition part 3 acquires as user information an operation history indicating that a user X browsing an evaluation subject has skipped an applause phase and moved directly to a new input phase from a browsing phase, and stores it in the user information storage part 7 (Step S1).

Next, the group determination part 4 determines, based on the user information stored in the user information storage part 7, that a user X's moving pattern is a behavioral pattern similar to that of group B in the group-behavioral characteristic table stored in the classification information storage part 9 shown in FIG. 10 (Step S2).

Next, the phase determination part 6, based on the user X's operation history indicated by the user information stored in the user information storage part 7, determines that a user X's current phase is a browsing phase (Step S3).

Next, the input-prompting part 5, in the browsing phase, with reference to the message determination table stored in the prompting information storage part 8, selects a message corresponding to group B (Step S4), and presents it to the user X, and thereby, induces the user X to the new input phase (Step S5).

Meanwhile, in many cases in a system for the purpose of collecting opinions with respect to a certain content, a few users input a comment positively with respect to this content among users who browse this content, and most users only browse this content and does not input comments. Consequently, a scheme capable of inducing a large number of users' comments is expected.

As compared with this, in the information-processing device according to the first embodiment of the present invention, the user information acquisition part 3 acquires user information indicating at least either of subject user's content of opinion with respect to one or more evaluation subjects and/or a subject user's operation history. The group determination part 4, based on the user information acquired by the user information acquisition part 3, determines a group to which the subject user belongs from among a plurality of groups. Then, the input-prompting part 5 presents, to the subject user, prompting information for the purpose of inducing the subject user to input a new evaluation subject or content of opinion with respect to a presented evaluation subject which is an evaluation subject presented to the subject user, based on a group to which the subject user belongs.

That is, in the information-processing device according to the first embodiment of the present invention, type-classifying of an individual is carried out based on a behavioral tendency or the like, and a content for working on the subject user is determined with reference to the past similar behavior type or the like. Thereby, it becomes possible to prompt input of a comment and a new article.

Therefore, based on a minimum configuration comprised of the user information acquisition part 3, group determination part 4 and input-prompting part 5 among each constituent in the information-processing device 201 according to the first embodiment of the present invention, it becomes possible to achieve the object of the present invention to collect opinions from a larger number of users.

In addition, in the information-processing device according to the first embodiment of the present invention, an operation until a subject user inputs a new evaluation subject or content of opinion with respect to a presented evaluation subject is classified into a plurality of stages i.e. phases. Then, the user information acquisition part 3 acquires user information indicating the subject user's operation history in each stage.

By such a configuration as this, it becomes possible to perform more appropriately group determination of a subject user based on an operation history.

In addition, in the information-processing device according to the first embodiment of the present invention, the user information acquisition part 3 acquires user information indicating a move history of a stage by a subject user.

By such a configuration as this, it becomes possible to perform more appropriately group determination of a subject user based on an operation history.

In addition, in the information-processing device according to the first embodiment of the present invention, the group determination part 4, based on the subject user's operation history in one or more stages to which the subject user has moved before a subject stage, or a stage move history by the subject user up to the subject stage, determines a group to which the subject user belongs from among a plurality of groups. Then, the input-prompting part 5, in a stage after the subject stage, presents prompting information to the subject user based on the group to which the subject user belongs.

By such a configuration as this, based on the subject user's operation history in a previous stage, it is possible to determine appropriately a group to which the subject user belongs, and to present more effectively prompting information with respect to the subject user.

In addition, in the information-processing device according to the first embodiment of the present invention, the input-prompting part 5, for every stage, based on a group to which the subject user belongs, presents prompting information for the purpose of inducing the subject user to the next stage. For example, the input-prompting part 5, in the comment creation phase, in addition to prompting information for the purpose of prompting a subject user to input a comment, can also present prompting information so as to induce the subject user to an article creation phase.

In this way, based on a configuration to induce a subject user in incremental steps, the subject user's opinion input can be prompted more effectively.

In addition, in the information-processing device according to the first embodiment of the present invention, the classification information storage part 9 stores classification information indicating a plurality of groups classified based on at least either of user's content of opinion with respect to an evaluation subject and/or an input record of content of opinion by a user. Then, the group determination part 4, based on the user information acquired by the user information acquisition part 3, determines the group to which the subject user belongs from among a plurality of groups indicated by this classification information.

In this way, based on a configuration using results classified in accordance with a prescribed classification rule, a group to which a subject user belongs can be determined by a simple process.

In addition, in the information-processing device according to the first embodiment of the present invention, the input-prompting part 5 determines a prompting information content for every group.

By such a configuration as this, prompting information having a more appropriate content can be presented to a subject user.

In addition, in the information-processing device according to the first embodiment of the present invention, the prompting information storage part 8 stores a correspondence relation between each group and a prescribed message. Then, the input-prompting part 5, from among messages stored in the prompting information storage part 8, selects a message corresponding to a group to which the subject user belongs as the prompting information.

In this way, based on the configuration using the correspondence relation between each group and a prescribed message, it is possible to select a message corresponding to a group to which the subject user belongs by a simple process.

Besides, in the information-processing device according to the first embodiment of the present invention, the input-prompting part 5 is made to be configured to present a message to a subject user as prompting information, and however, it is not limited to this. The input-prompting part 5 may be configured to present, to a subject user, not only a message, but also an image, voice and light or the like as prompting information.

In addition, in the first embodiment of the present invention, the user information acquisition part 3 may be configured to acquire user information indicating both a subject user's operation history in each phase and a phase move history by a subject user, and the group determination part 4, based on the combination between them, may be configured to determine a group to which the subject user belongs from among a plurality of groups.

In addition, in the information-processing device according to the first embodiment of the present invention, a stage where a subject user browses a presented evaluation subject; a stage where a subject user evaluates a presented evaluation subject; a stage where a subject user inputs content of opinion with respect to a presented evaluation subject; and a stage where a subject user inputs a new evaluation subject, are made to be configured, and however, it is not limited to this. For example, a stage where a subject user browses each user's content of opinion with respect to a presented evaluation subject may be further configured.

In addition, if at least any two of these two or more stages are made up to be configured, by dividing a part or all of operations until a subject user inputs a new evaluation subject or content of opinion with respect to a presented evaluation subject into a plurality of stages, it becomes possible to perform group determination of a subject user more appropriately.

In addition, in the first embodiment of the present invention, the stage where a subject user browses a presented evaluation subject may be divided into a stage where a subject user browses a presented evaluation subject in a short time and a stage where a subject user browses it in a long time.

In this case, the input-prompting part 5 presents prompting information to induce a subject user from the stage where the subject user browses a presented evaluation subject in a short time to the stage where the subject user browses a presented evaluation subject in a long time. Specifically, the input-prompting part 5, in the stage where a subject user browses a presented evaluation subject in a short time, presents a message such as “Let's try to look at one article deliberately now”.

By such a configuration as this, in a browsing stage of a presented evaluation subject, it is possible to induce a subject user appropriately toward an input stage of content of opinion or a new evaluation subject.

In addition, in the first embodiment of the present invention, the stage where a subject user browses each user's content of opinion with respect to a presented evaluation subject may be divided into a stage where a subject user browses each user's content of opinion with respect to a presented evaluation subject in a short time and a stage where a subject user browses it in a long time.

In this case, the input-prompting part 5 presents prompting information to induce a subject user from the stage where the subject user browses content of opinion in a short time to the stage where the subject user browses content of opinion in a long time. Specifically, the input-prompting part 5, in the stage where a subject user browses each user's content of opinion with respect to a presented evaluation subject in a short time, presents a message such as “Let's try to look at one comment deliberately now”.

By such a configuration as this, in the browsing stage of each user's content of opinion with respect to a presented evaluation subject, it is possible to induce a subject user appropriately toward an input stage of content of opinion or a new evaluation subject.

In addition, in the information-processing device according to the first embodiment of the present invention, the classification information storage part 9 is made to be configured to store a user's content of opinion with respect to an evaluation subject, and classification information indicating a user's operation history, and however, it is not limited to this.

The classification information storage part 9 may be configured to store classification information indicating a plurality of groups classified based on at least either of a user's content of opinion with respect to an evaluation subject and/or a user's operation history. In addition, classification based on such content of opinion and operation history may be configured using a past actual record, and a manager may configure a classification content in advance.

Next, an other embodiment of the present invention will be described using the figures. It is noted that the same reference character will be is given to the same or corresponding part in the figures, and thus the description will not be repeated.

### Second Embodiment

The present embodiment, as compared with the information-processing device according to the first embodiment of the present invention, relates to an information-processing device which controls a presenting timing of prompting information. It is the same as the information-processing device according to the first embodiment except for a content described in the following.

In the information-processing device according to the second embodiment of the present invention, the input-prompting part 5, in the case where a subject user does not move to a new phase even if prescribed time has elapsed after the subject user has moved to a certain phase, presents prompting information to the subject user.

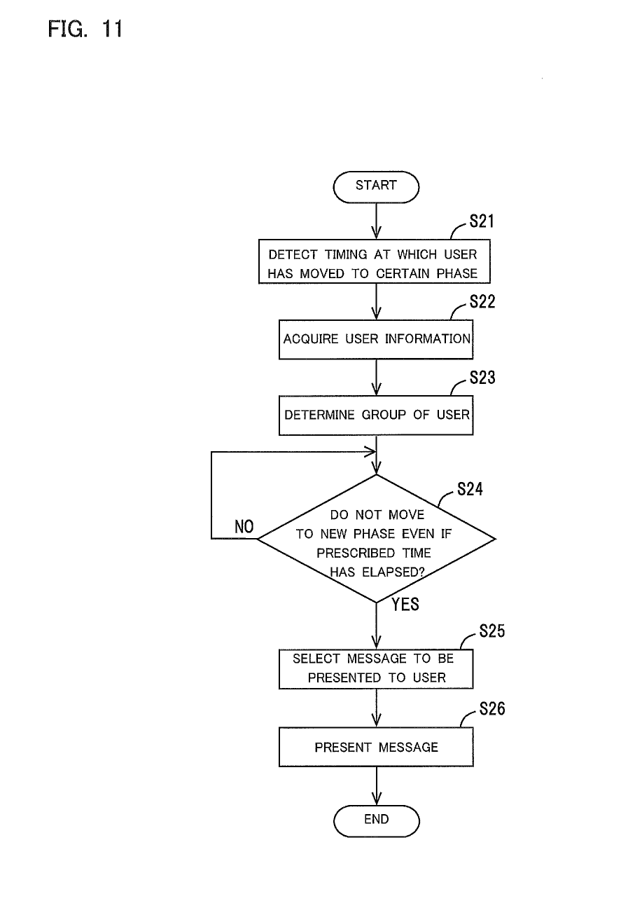

FIG. 11 is a flow chart showing an operation procedure in the case where the information-processing device according to the second embodiment of the present invention performing comment-prompting processing.

With reference to FIG. 11, first, the input-prompting part 5 detects a timing at which a user has moved to a certain phase (Step S21).

Next, the user information acquisition part 3 acquires user information indicating an operation history or the like of this user (Step S22).

Next, the group determination part 4, with reference to the group-behavioral characteristic table stored in the classification information storage part 9, determines a group to which the user belongs based on the user information acquired by the user information acquisition part 3 (Step S23).

Next, the input-prompting part 5 stands by after the timing at which the user has moved to this phase until a prescribed time elapses (NO at Step S24). Then, the input-prompting part 5, in the case where a user does not move to a new phase even if prescribed time elapses after the timing at which the user has moved to this phase (YES at Step S24), with reference to the prompting information storage part 8, based on the determination result by the group determination part 4, selects a message corresponding to a group to which the subject user belongs (Step S25).

Then, the input-prompting part 5 presents the selected message to a user by displaying it on a screen or the like (Step S26).

In addition, in the information-processing device according to the second embodiment of the present invention, in the new input phase, the input-prompting part 5 presents prompting information to the subject user in the case where a new evaluation subject or content of opinion with respect to a presented evaluation subject is not inputted even if prescribed time has elapsed after a prescribed timing.

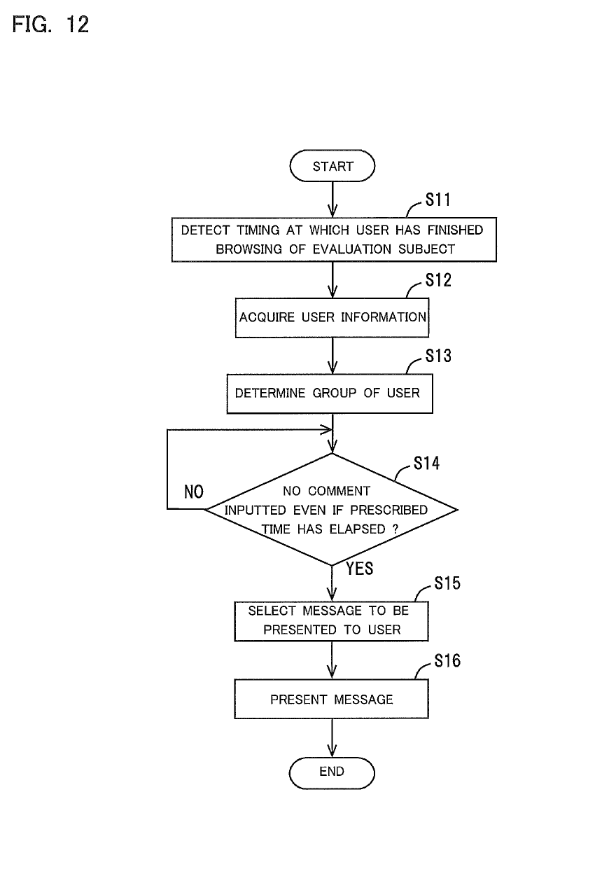

FIG. 12 is a flow chart showing an operation procedure in the case where the information-processing device according to the second embodiment of the present invention performs comment-prompting processing.

With reference to FIG. 12, first, the input-prompting part 5, for example, detects a timing at which a user has finished browsing of an evaluation subject (Step S11).

Here, a timing at which browsing is finished, for example, can be acquired by detecting a timing at which a user has performed an operation to browse a WEB page other than a WEB page on which an evaluation subject is indicated, a timing at which a WEB page on which an evaluation subject is indicated has been closed, or a timing at which a user has moved to a new input phase, i.e., a timing at which a user has performed an operation to browse a WEB page into which an comment or a new article with respect to evaluation subject is to be inputted.

Next, the user information acquisition part 3 acquires user information indicating an operation history or the like of a user who has finished browsing of an evaluation subject (Step S12).

Next, the group determination part 4, with reference to the group-behavioral characteristic table stored in the classification information storage part 9, based on user information acquired by the user information acquisition part 3, determines a group to which the user belongs (Step S13).

Next, the input-prompting part 5 stands by after a timing at which a user has finished browsing of an evaluation subject until a prescribed time elapses (NO at Step S14). Then, the input-prompting part 5, in the case where a user does not input a comment with respect to an evaluation subject even if prescribed time elapses after the timing at which the user has finished browsing of an evaluation subject (YES at Step S14), with reference to the prompting information storage part 8, based on the determination result by the group determination part 4, selects a message corresponding to a group to which the subject user belongs (Step S15).

Then, the input-prompting part 5 presents the selected message to a user by displaying it on a screen or the like.

Besides, the input-prompting part 5, in every prescribed time, for example, in every 10 seconds after above-mentioned each prescribed timing, may be configured to present a message to prompt move to a new phase or new input.

As mentioned above, in the information-processing device according to the second embodiment of the present invention, the input-prompting part 5, in the case where a subject user does not move to anew stage even if prescribed time has elapsed after the subject user has moved to a certain stage, presents prompting information to the subject user.

By such a configuration as this, since prompting information can be presented, at an appropriate timing, to a user who does not move to the next stage, it is possible to prompt further a subject user to move to the next stage.

In addition, in the information-processing device according to the second embodiment of the present invention, the input-prompting part 5, in the case where a new evaluation subject or content of opinion with respect to a presented evaluation subject is not inputted even if prescribed time has elapsed after a prescribed timing, presents prompting information to the subject user.

By such a configuration as this, since prompting information can be presented, at an appropriate timing, to a user who has not performed an input operation, it is possible to prompt further an input operation of the subject user.

Since other configurations and operations are the same as those of the information-processing device according to the first embodiment, detailed descriptions are not repeated here.

Next, an other embodiment of the present invention will be described using the figures. It is noted that the same reference character will be is given to the same or corresponding part in the figures, and thus the description will not be repeated.

### Third Embodiment

The present embodiment, as compared with the information-processing device according to the second embodiment, relates to an information-processing device which determines a presenting timing of prompting information for every group. It is the same as the information-processing device according to the second embodiment except for a content described in the following.

In the information-processing device according to the third embodiment of the present invention, the input-prompting part 5, determines for every group a presenting method, for example, a presenting timing of prompting information.

In more details, the input record information acquisition part 1 acquires input record information indicating a record in which each user in a group to which a subject user belongs has inputted content of opinion with respect to one or more evaluation subjects.

The input-prompting part 5, based on the input record information acquired by the input record information acquisition part 1, determines a presenting timing of prompting information.

Specifically, the input record information acquisition part 1 acquires standby time after a prescribed timing until each user starts inputting of content of opinion with respect to one or more evaluation subjects.

The input-prompting part 5, based on each user's standby time in a group to which the subject user belongs, calculates a presenting timing of prompting information.

For example, the input-prompting part 5 creates a frequency distribution of each user's standby time in a group to which the subject user belongs, and based on the created frequency distribution, calculates a presenting timing of prompting information.

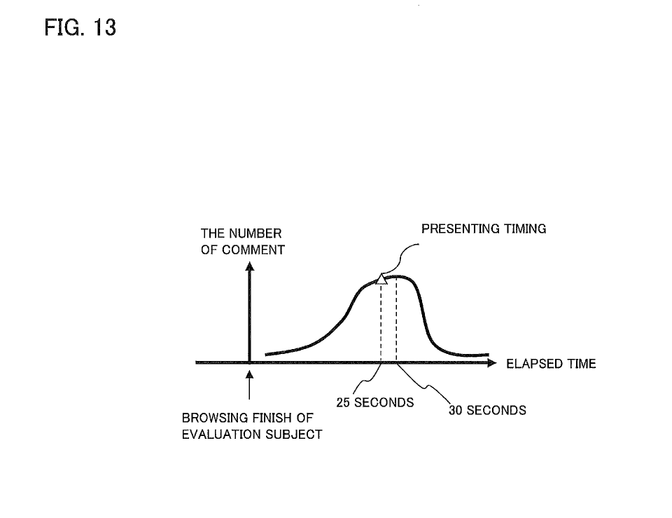

FIG. 13 is a figure showing a frequency distribution of standby time until comment input with respect to an evaluation subject.

With reference to FIG. 13, the input record information acquisition part 1 acquires standby time until each user inputs a comment with respect to one or more evaluation subjects, and stores it in the input record information storage part 2.

The input-prompting part 5, for example, for every group of a user in the message determination table shown in FIG. 5, creates a frequency distribution of each standby time stored in the input record information storage part 2.

Specifically, for example, in the case where a subject user belongs to a group where average standby time is a “middle” level and average number of input characters is a “large” level, the input-prompting part 5 creates a frequency distribution of this group.

Then, the input-prompting part 5, since many users belonging to this group inputs a comment at 30 seconds after a browsing finish time of an article which is an evaluation subject, presents a message “Considering a little, please present a long comment” at the timing a little before 30 seconds, for example, at 25 seconds.

That is, the input-prompting part 5 configures the prescribed time in Step S14 of the flow chart shown in FIG. 12 as the time of prescribed time smaller than 30 seconds.

Besides, this frequency distribution may be a frequency distribution of standby time with respect to one evaluation subject, for example, presented evaluation subject, and may be a frequency distribution of standby time with respect to a plurality of evaluation subjects.

In addition, the input-prompting part 5 may have not only a configuration to create a frequency distribution of standby time of a group to which the subject user belongs, but also a configuration to create a frequency distribution of standby time of only a subject user and determine a message presenting timing.

Next, other examples with respect to a determination method of a presenting timing of prompting information will be described.

The input record information acquisition part 1 acquires input record information indicating a record in which each user has inputted content of opinion with respect to other evaluation subjects other than a presented evaluation subject.

The user information acquisition part 3 acquires, as an operation history, user information indicating a record in which a subject user has inputted content of opinion with respect to other evaluation subjects.

The group determination part 4 classifies users into a plurality of groups based on the input record information acquired by the input record information acquisition part 1, and based on the user information acquired by the user information acquisition part 3, determines a group to which the subject user belongs from among a plurality of groups.

The input-prompting part 5, based on the group to which the subject user belongs, calculates a presenting timing of prompting information.

Specifically, the input-prompting part 5 classifies users based on a comment log with respect to each article, i.e., determines a user's standby time type, and based on this standby time type, determines a presenting timing of prompting information.

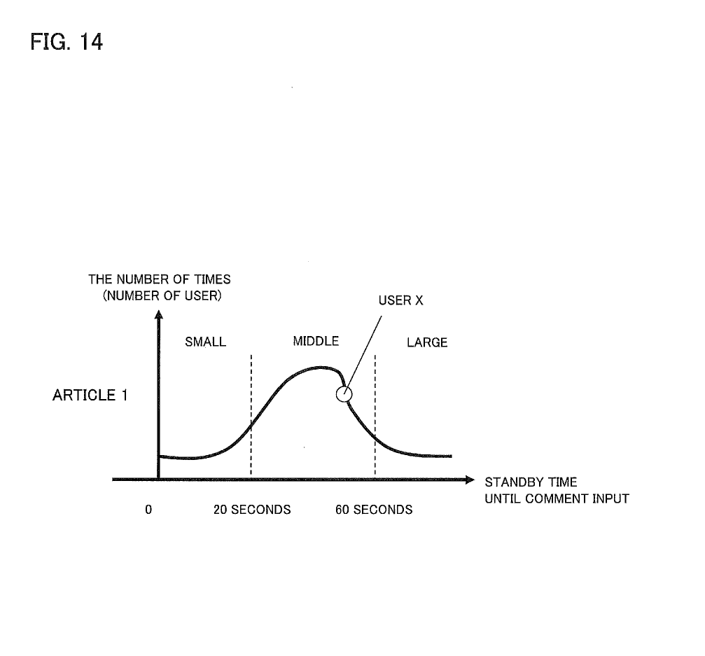

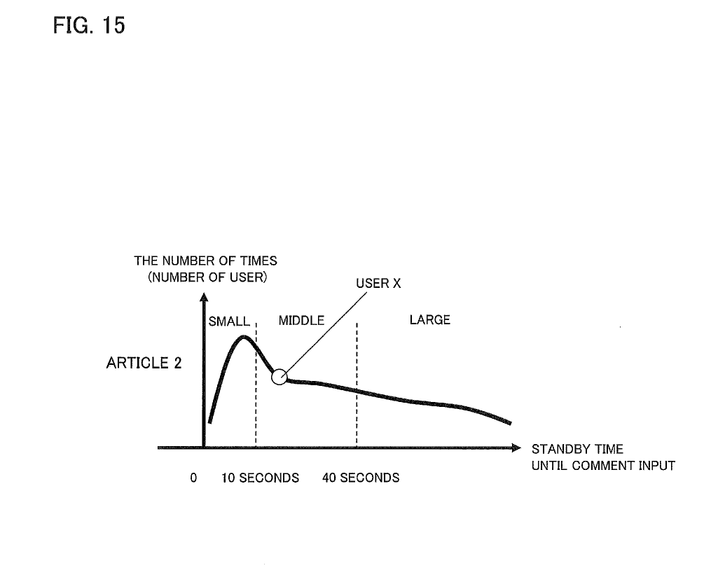

FIG. 14 and FIG. 15 are figures showing a frequency distribution of standby time until comment input of each user who has browsed a certain article.

With reference to FIG. 14, the input record information acquisition part 1 acquires standby time until each user's comment input with respect to an article 1 which is an evaluation subject, and stores it in the input record information storage part 2.

The input-prompting part 5, with respect to the article 1, creates a frequency distribution of each standby time stored in the input record information storage part 2.

The input-prompting part 5, in the frequency distribution of each user who has browsed the article 1, configures as “small” the standby time type of a user whose standby time until comment input is 0 second to 20 seconds, and configures as “middle” the standby time type of a user whose standby time until comment input is 20 seconds to 60 seconds, and configures as “large” the standby time type of a user whose standby time until comment input is no less than 60 seconds.

With reference to FIG. 15, the input record information acquisition part 1 acquires standby time until each user's comment input with respect to an article 2 which is an evaluation subject, and stores it in the input record information storage part 2.

The input-prompting part 5, with respect to article 2, creates a frequency distribution of each standby time stored in the input record information storage part 2.

The input-prompting part 5, in the frequency distribution of each user who has browsed the article 2, configures as “small” the standby time type of a user whose standby time until comment input is 0 second to 10 seconds, and configures as “middle” the standby time type of a user whose standby time until comment input is 10 seconds to 40 seconds, and configures as “large” the standby time type of a user whose standby time until comment input is no less than 40 seconds.

Although not illustrated, in the same way, the input-prompting part 5 creates a frequency distribution also with respect to an article 3 and article 4, and configures a standby time type of “small”, “middle”, or “large”.

Then, the input-prompting part 5, based on the created frequency distribution of each article, and standby time until comment input with respect to each article of the subject user, determines a group to which the subject user belongs, i.e., determines a standby time type of the subject user.

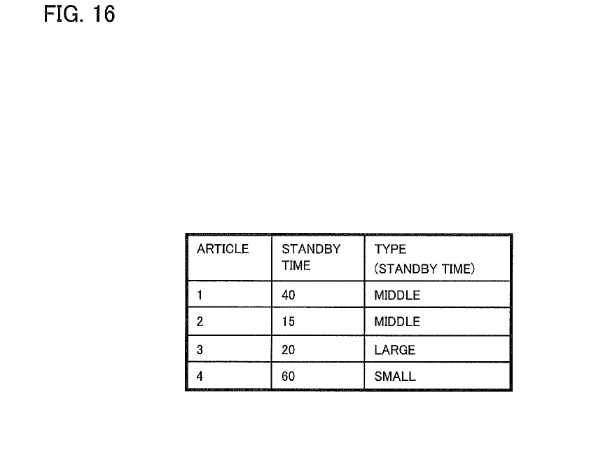

FIG. 16 is a figure showing standby time and a standby time type with respect to each article of the subject user.

FIG. 16 shows that: standby time of a user X who has browsed the article 1 is 40 seconds and a standby time type thereof is “middle”; standby time of a user X who has browsed the article 2 is 15 seconds and a standby time type thereof is “middle”; standby time of a user X who has browsed the article 3 is 20 seconds and a standby time type thereof is “large”; standby time of a user X who has browsed the article 4 is 60 seconds and a standby time type thereof is “small”.

In this case, the input-prompting part 5 determines the “middle” which is the most with respect to each article as the standby time type of the user X.

Besides, the input record information acquisition part 1 may be configured to acquire standby time until each user's comment input with respect to at least one article.

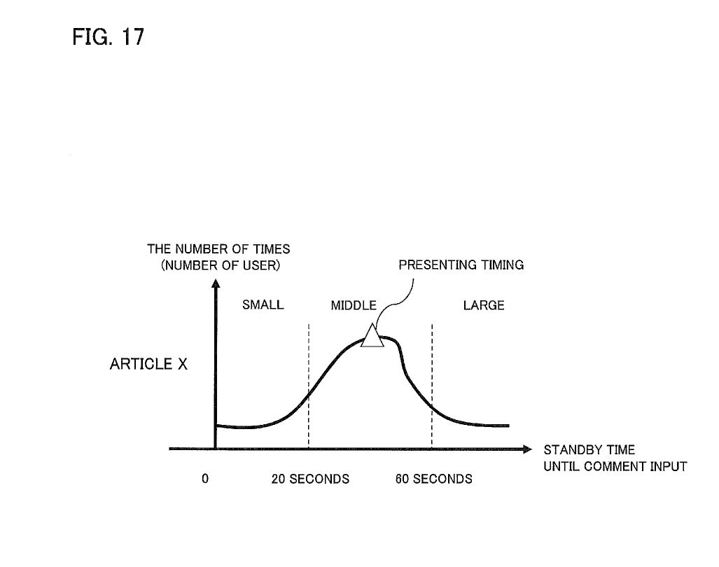

FIG. 17, with respect to each user who has browsed an article X, is a figure showing a frequency distribution of standby time until comment input and a presenting timing of prompting information with respect to a subject user.

With reference to FIG. 17, the input record information acquisition part 1 acquires standby time until each user's comment input with respect to the article X which is an evaluation subject, and stores it in the input record information storage part 2.

The input-prompting part 5, with respect to the article X, creates a frequency distribution of each standby time stored in the input record information storage part 2, and configures a standby time type of “small”, “middle”, or “large”. Specifically, the input-prompting part 5, in the frequency distribution of each user who has browsed the article X, configures as “small” the standby time type of a user whose standby time until comment input is 0 second to 20 seconds, and configures as “middle” the standby time type of a user whose standby time until comment input is 20 seconds to 60 seconds, and configures as “large” the standby time type of a user whose standby time until comment input is no less than 60 seconds.

Then, the input-prompting part 5, with respect to the user X who is browsing the article X and has not yet inputted a comment, since a standby time type of the user X is “middle”, configures as standby time 40 seconds which is a median, for example, of “middle” types in the created frequency distribution.

That is, the input-prompting part 5 configures the prescribed time in Step S14 of a flow chart shown in FIG. 12 as the median of “middle” types in the frequency distribution of the article X.

Besides, in the third embodiment of the present invention, presenting of prompting information in the comment creation phase has been illustrated and described, and with respect to presenting of prompting information in the article creation phase, the same operation will be also performed.

As mentioned above, in the information-processing device according to the third embodiment of the present invention, the input-prompting part 5 determines a presenting method of prompting information for every group.

By such a configuration as this, it is possible to present prompting information to a subject user more effectively.

In addition, in the information-processing device according to the third embodiment of the present invention, the input-prompting part 5 determines a presenting timing of prompting information for every group.

By such a configuration as this, since it is possible to present prompting information to a subject user at an appropriate timing, a subject user's input operation can be prompted further.

In addition, in the information-processing device according to the third embodiment of the present invention, the input record information acquisition part 1 acquires input record information indicating a record in which each user in a group to which a subject user belongs has inputted content of opinion with respect to one or more evaluation subjects. Then, the input-prompting part 5, based on the input record information acquired by the input record information acquisition part 1, determines a presenting method of prompting information.

In this way, based on a configuration to determine an appropriate presenting method of prompting information using an input record of each user's content of opinion, it is possible to prompt further a subject user's input operation.

In addition, in the information-processing device according to the third embodiment of the present invention, the input record information acquisition part 1 acquires standby time after a prescribed timing until each user starts inputting of content of opinion with respect to one or more evaluation subjects. Then, the input-prompting part 5, based on each user's standby time in a group to which the subject user belongs, calculates a presenting timing of prompting information.

By such a configuration as this, it is possible to acquire an appropriate presenting timing using each user's standby time. Besides, the above-mentioned prescribed timing, for example, may be a timing at which each user starts browsing of each evaluation subject, and may be a timing at which each user finishes browsing of each evaluation subject.

In addition, in the information-processing device according to the third embodiment of the present invention, the input-prompting part 5 creates a frequency distribution of each user's standby time in a group to which the subject user belongs, and calculates a presenting timing of prompting information based on the created frequency distribution.

By such a configuration as this, it is possible to acquire an appropriate presenting timing using a frequency distribution of each user's standby time.

In addition, in the information-processing device according to the third embodiment of the present invention, the input record information acquisition part 1 acquires the input record information indicating a record in which each user has inputted content of opinion with respect to other evaluation subjects other than a presented evaluation subject. The user information acquisition part 3, as an operation history, acquires user information indicating a record in which a subject user has inputted content of opinion with respect to above-mentioned other evaluation subjects. The group determination part 4 classifies users into a plurality of groups based on the input record information acquired by the input record information acquisition part 1, and based on the user information acquired by the user information acquisition part 3, determines a group to which the subject user belongs from among a plurality of groups. Then, the input-prompting part 5 calculates a presenting timing of prompting information based on the group to which the subject user belongs.

By such a configuration as this, with respect to other evaluation subjects other than a presented evaluation subject, an appropriate presenting timing can be acquired using an input record of content of opinion by the subject user and an input record of content of opinion by each user.

Besides, in the information-processing device according to the third embodiment of the present invention, the input-prompting part 5 is made to be configured to determine a message presenting timing for every group, and however, it is not limited to this.

The input-prompting part 5 may be configured to change not only a presenting timing, but also a color, brightness and font or the like of a message as a message presenting method.

In addition, in the information-processing device according to the third embodiment of the present invention, the input record information acquisition part 1 is made to be configured to acquire a user's standby time until comment input as input record information, and however, it is not limited to this. The input record information acquisition part 1 may be configured to acquire, as input record information, a typing speed by a user, i.e., a character input speed by a user, the number of times where a backspace key is pressed, and the number of times where an undo operation is performed, when a user inputs content of opinion.

Since other configurations and operations are the same as those of the information-processing device according to the second embodiment, detailed descriptions are not repeated here.

Next, an other embodiment of the present invention will be described using the figures. It is noted that the same reference character will be is given to the same or corresponding part in the figures, and thus the description will not be repeated.

### Fourth Embodiment

The present embodiment, as compared with the information-processing device according to the first embodiment of the present invention, relates to an information-processing device with a classification criterion of user changed. It is the same as the information-processing device according to the first embodiment except for a content described in the following.

In the information-processing device according to the fourth embodiment of the present invention, the user information acquisition part 3 acquires user information indicating attributes of a subject user, and stores it in the user information storage part 7.

The group determination part 4, based on the user information acquired by the user information acquisition part 3, determines a group to which the subject user belongs from among a plurality of groups.

In more details, the classification information storage part 9 stores classification information indicating a plurality of groups classified based on attributes of a user.

The group determination part 4, based on the user information acquired by the user information acquisition part 3, determines a group to which the subject user belongs from among a plurality of groups indicated by this classification information.

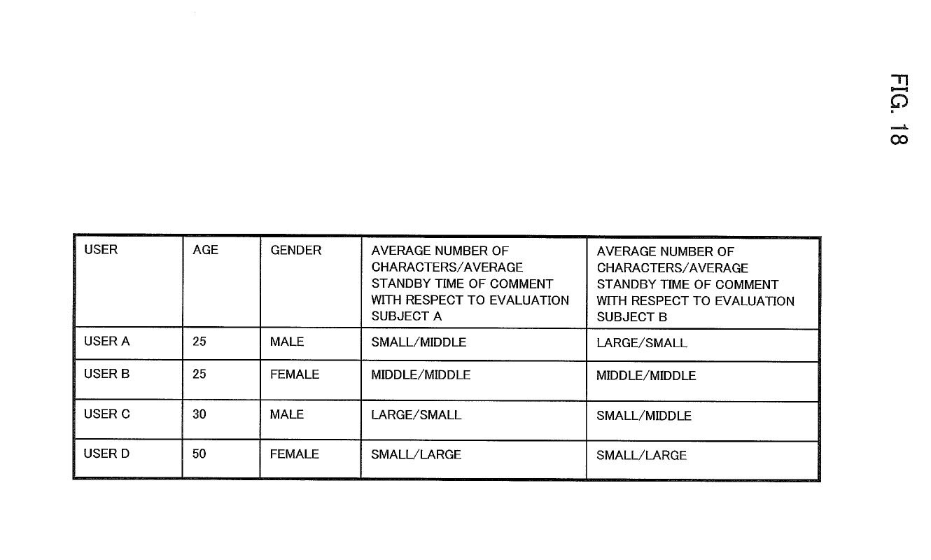

FIG. 18 is a figure showing an example of a user table in the information-processing device according to the fourth embodiment of the present invention.

With reference to FIG. 18, the user table is a table which indicates individual attributes of each user, and indicates a level of the average number of input characters and average standby time of a comment of each user with respect to each evaluation subject.

In this user table, user A is indicated as follows: age is 25; gender is male; a level of the average number of input characters of a comment with respect to an evaluation subject A is “small”, and a level of average standby time is “middle”; a level of the average number of input characters of a comment with respect to an evaluation subject B is “large”, and a level of average standby time is “small”.

In addition, user B is indicated as follows: age is 25; gender is female; a level of the average number of input characters of a comment with respect to an evaluation subject A is “middle”, and a level of average standby time is “middle”; a level of the average number of input characters of a comment with respect to an evaluation subject B is “middle”, and a level of average standby time is “middle”.

In addition, user C is indicated as follows: age is 30; gender is male; a level of the average number of input characters of a comment with respect to an evaluation subject A is “large”, and a level of average standby time is “small”; a level of the average number of input characters of a comment with respect to an evaluation subject B is “small”, and a level of average standby time is “middle”.

In addition, user D is indicated as follows: age is 50; gender is female; a level of the average number of input characters of a comment with respect to an evaluation subject A is “small”, and a level of average standby time is “large”; a level of the average number of input characters of a comment with respect to an evaluation subject B is “small”, and a level of average standby time is “large”.

The user information storage part 7 stores this user table. In addition, in the prompting information storage part 8, a message table indicating a message corresponding to each user listed in this user table is stored.

The input-prompting part 5, with respect to a user having the same attribute, selects and displays a message corresponding to this attribute. In more details, the group determination part 4 determines a group to which the subject user belongs, i.e., refers to the user table stored in the user information storage part 7, and based on attributes of the subject user indicated by the user information stored in the user information storage part 7, retrieves a user corresponding to the subject user.

The input-prompting part 5, with reference to the message table stored in the prompting information storage part 8, selects a message corresponding to the user retrieved by the group determination part 4.

For example, the input-prompting part 5, in the case where a user X who is browsing an evaluation subject A is a male who is 25 years old, selects and presents “Considering a little, please present a short comment” which is a message corresponding to a user A.

As mentioned above, in the information-processing device according to the fourth embodiment of the present invention, the user information acquisition part 3 acquires user information indicating attributes of the subject user. The group determination part 4, based on the user information acquired by the user information acquisition part 3, determines a group to which the subject user belongs from among a plurality of groups. Then, the input-prompting part 5 presents to the subject user, based on a group to which the subject user belongs, prompting information for the purpose of inducing the subject user to input a new evaluation subject or content of opinion with respect to a presented evaluation subject which is an evaluation subject presented to the subject user.

That is, in the information-processing device according to the fourth embodiment of the present invention, type-classifying of an individual is carried out based on individual attributes, and with reference to attributes of other user, a content for working on the subject user is determined. Thereby, it becomes possible to prompt input of a comment and new article.

Therefore, based on a minimum configuration comprised of the user information acquisition part 3, group determination part 4, and input-prompting part 5 among each constituent in the information-processing device according to the fourth embodiment of the present invention, it becomes possible to achieve the object of the present invention to collect opinions from a larger number of users.

In addition, in the information-processing device according to the fourth embodiment of the present invention, the classification information storage part 9 stores classification information indicating a plurality of groups classified based on attributes of a user. Then, the group determination part 4, based on the user information acquired by the user information acquisition part 3, determines a group to which the subject user belongs from among a plurality of groups indicated by the classification information.

In this way, based on a configuration using a result classified in accordance with a prescribed classification rule, it is possible to determine a group to which the subject user belongs by a simple process.

Besides, in the information-processing device according to the fourth embodiment of the present invention, the classification information storage part 9 is made to be configured to store the classification information indicating a plurality of groups classified based on attributes of a user, and however, the classification based on user attributes like this may be configured by using attributes of a user who has inputted comments or the like in the past, and a manager may configure a classification content in advance.

Since other configurations and operations are the same as those of the information-processing device according to the first embodiment, detailed descriptions are not repeated here.

A part or all of the above-mentioned embodiments are described also as the following additional statements, and however, the scope of the present invention is not limited to the following additional statements.

[Additional Statement 1]

An information-processing device, comprising:

a user information acquisition part configured to acquire user information indicating at least one of an attribute of a subject user, said subject user's content of opinion with respect to one or more evaluation subjects, and said subject user's operation history;

a group determination part configured to determine a group to which said subject user belongs from among a plurality of groups based on user information acquired by said user information acquisition part; and

an input-prompting part configured to present, to said subject user based on said group to which said subject user belongs, prompting information for inducing said subject user to input a new evaluation subject or content of opinion with respect to a presented evaluation subject which is an evaluation subject presented to said subject user.

[Additional Statement 2]

The information-processing device according to Additional statement 1, wherein

an operation until said subject user inputs a new evaluation subject or content of opinion with respect to said presented evaluation subject is classified into a plurality of stages, and

said user information acquisition part acquires user information indicating said subject user's operation history in each said stage.

[Additional Statement 3]

The information-processing device according to Additional statement 1 or 2, wherein

an operation until said subject user inputs a new evaluation subject or content of opinion with respect to said presented evaluation subject is classified into a plurality of stages, and

said user information acquisition part acquires user information indicating a move history of said stage by said subject user.

[Additional Statement 4]

The information-processing device according to Additional statement 2 or 3, wherein

said group determination part, based on at least either of said subject user's operation history in one or more said stages to which said subject user has moved before a subject stage and/or a move history of said stages by said subject user up to said subject stage, determines a group to which said subject user belongs from among a plurality of groups, and

said input-prompting part, in said subject stage or said stage to which said subject user moves after said subject stage, presents said prompting information to said subject user based on said group to which said subject user belongs.

[Additional Statement 5]

The information-processing device according to any of Additional statements 1 to 4, wherein

an operation until said subject user inputs a new evaluation subject or content of opinion with respect to said presented evaluation subject is classified into a plurality of stages, and

said input-prompting part, for every said stage, based on said group to which said subject user belongs, presents said prompting information for inducing said subject user to a next stage.

[Additional Statement 6]

The information-processing device according to any of Additional statements 2 to 5, wherein

said two or more stages include at least any two of: a stage where said subject user browses said presented evaluation subject; a stage where said subject user browses each user's content of opinion with respect to said presented evaluation subject; a stage where said subject user evaluates said presented evaluation subject; a stage where said subject user inputs content of opinion with respect to said presented evaluation subject; and a stage where said subject user inputs a new evaluation subject.

[Additional Statement 7]

The information-processing device according to Additional statement 6, wherein

said two or more stages include at least a stage where said subject user browses said presented evaluation subject in a short time and a stage where said subject user browses it in a long time, or include at least a stage where said subject user browses each user's content of opinion with respect to said presented evaluation subject in a short time and a stage where said subject user browses it in a long time, and

said input-prompting part presents said prompting information for purpose of inducing said subject user from a stage where said subject user browses said presented evaluation subject or said content of opinion in a short time to a stage where said subject user browses said presented evaluation subject or said content of opinion in a long time.

[Additional Statement 8]

The information-processing device according to any of Additional statements 2 to 7, wherein

said input-prompting part, in the case where even if prescribed time has elapsed after said subject user has moved to a certain said stage, said subject user does not move to a new said stage, presents said prompting information to said subject user.

[Additional Statement 9]

The information-processing device according to any of Additional statements 1 to 8, further comprising

a classification information storage part configured to store classification information indicating a plurality of groups classified based on at least one of a user's content of opinion with respect to an evaluation subject, a user's operation history, and a user's attribute,

wherein

said group determination part, based on user information acquired by said user information acquisition part, determines a group to which said subject user belongs from among said two or more groups indicated by said classification information.

[Additional Statement 10]

The information-processing device according to any of Additional statements 1 to 9, wherein

said input-prompting part determines content of said prompting information for every said group.

[Additional Statement 11]

The information-processing device according to Additional statement 10, further comprising

a message storage part configured to store a correspondence relation between each said group and a prescribed message,

wherein

said input-prompting part, from among said messages stored by said message storage part, selects said message corresponding to said group to which said subject user belongs as said prompting information.

[Additional Statement 12]

The information-processing device according to any of Additional statements 1 to 11, wherein

said input-prompting part determines a presenting method of said prompting information for every said group.

[Additional Statement 13]

The information-processing device according to Additional statement 12, wherein

said input-prompting part determines a presenting timing of said prompting information for every said group.

[Additional Statement 14]

The information-processing device according to Additional statements 12 or 13, further comprising

an input record information acquisition part configured to acquire input record information indicating a record in which each user in a group to which said subject user belongs has inputted content of opinion with respect to one or more evaluation subjects,

wherein

said input-prompting part, based on said input record information acquired by said input record information acquisition part, determines a presenting method of said prompting information.

[Additional Statement 15]

The information-processing device according to any of Additional statements 1 to 14, wherein

said input-prompting part, in the case where even if prescribed time has elapsed after a prescribed timing, anew evaluation subject or content of opinion with respect to said presented evaluation subject is not inputted, presents said prompting information to said subject user.

[Additional Statement 16]

The information-processing device according to Additional statement 15, further comprising

an input record information acquisition part configured to acquire standby time after said prescribed timing until each user starts inputting of content of opinion with respect to one or more evaluation subjects,

wherein

said input-prompting part, based on said standby time of each user in said group to which said subject user belongs, calculates said prescribed time.

[Additional Statement 17]

The information-processing device according to Additional statement 16, wherein

said input-prompting part creates a frequency distribution of said standby time of each user in said group to which said subject user belongs, and calculates said prescribed time based on a created frequency distribution.

[Additional Statement 18]

The information-processing device according to Additional statement 15, further comprising

an input record information acquisition part configured to acquire input record information indicating a record in which each user has inputted content of opinion with respect to other evaluation subjects other than said presented evaluation subject,

wherein

said user information acquisition part, as said operation history, acquires user information indicating a record in which said subject user has inputted content of opinion with respect to said other evaluation subjects, and

said group determination part classifies users into a plurality of groups based on said input record information acquired by said input record information acquisition part, and based on said user information acquired by said user information acquisition part, determines a group to which said subject user belongs from among said two or more groups, and

said input-prompting part calculates said prescribed time based on said group to which said subject user belongs.

[Additional Statement 19]

A comment-prompting method comprising:

a step to acquire user information indicating at least one of an attribute of a subject user, said subject user's content of opinion with respect to one or more evaluation subjects, and said subject user's operation history;

a step to determine a group to which said subject user belongs from among a plurality of groups based on said user information; and

a step to present, to said subject user, based on said group to which said subject user belongs, prompting information for inducing said subject user to input a new evaluation subject or content of opinion with respect to a presented evaluation subject which is an evaluation subject presented to said subject user.

[Additional Statement 20]

The comment-prompting method according to Additional statement 19, wherein

an operation until said subject user inputs a new evaluation subject or content of opinion with respect to said presented evaluation subject is classified into a plurality of stages, and

in a step to acquire said user information, acquired is user information indicating said subject user's operation history in each said stage.

[Additional Statement 21]

The comment-prompting method according to Additional statement 19 or 20, wherein

an operation until said subject user inputs a new evaluation subject or content of opinion with respect to said presented evaluation subject is classified into a plurality of stages, and

in a step to acquire said user information, acquired is user information indicating a move history of said stage by said subject user.

[Additional Statement 22]

The comment-prompting method according to Additional statement 20 or 21, wherein

in a step to determine said group, based on at least either of said subject user's operation history in one or more said stages to which said subject user has moved before a subject stage and/or a move history of said stages by said subject user up to said subject stage, determined is a group to which said subject user belongs from among a plurality of groups, and

in a step to present said prompting information, in said subject stage or said stage to which said subject user moves after said subject stage, presented is said prompting information to said subject user based on said group to which said subject user belongs.

[Additional Statement 23]

The comment-prompting method according to any of Additional statements 19 to 22, wherein

an operation until said subject user inputs a new evaluation subject or content of opinion with respect to said presented evaluation subject is classified into a plurality of stages, and

in a step to present said prompting information, for every said stage, presented is said prompting information for inducing said subject user to a next stage based on said group to which said subject user belongs.

[Additional Statement 24]

The comment-prompting method according to any of Additional statements 20 to 23, wherein

said two or more stages include at least any two of: a stage where said subject user browses said presented evaluation subject; a stage where said subject user browses each user's content of opinion with respect to said presented evaluation subject; a stage where said subject user evaluates said presented evaluation subject; a stage where said subject user inputs content of opinion with respect to said presented evaluation subject; and a stage where said subject user inputs a new evaluation subject.

[Additional Statement 25]

The comment-prompting method according to Additional statement 24, wherein

said two or more stages include at least a stage where said subject user browses said presented evaluation subject in a short time and a stage where said subject user browses it in a long time, or include at least a stage where said subject user browses each user's content of opinion with respect to said presented evaluation subject in a short time and a stage where said subject user browses it in a long time, and

in a step to present said prompting information, presented is said prompting information for purpose of inducing said subject user from a stage where said subject user browses said presented evaluation subject or said content of opinion in a short time to a stage where said subject user browses said presented evaluation subject or said content of opinion in a long time.

[Additional Statement 26]

The comment-prompting method according to any of Additional statements 20 to 25, wherein

in a step to present said prompting information, in the case where even if prescribed time has elapsed after said subject user has moved to a certain said stage, said subject user does not move to a new said stage, presented is said prompting information to said subject user.

[Additional Statement 27]

The comment-prompting method according to any of Additional statements 19 to 26, further comprising

a step to acquire classification information indicating a plurality of groups classified based on at least one of a user's content of opinion with respect to an evaluation subject, a user's operation history, and a user's attribute,

wherein

in a step to determine said group, based on acquired said user information, determines a group to which said subject user belongs from among said two or more groups indicated by acquired said classification information.

[Additional Statement 28]

The comment-prompting method according to any of Additional statements 19 to 27, wherein

in a step to present said prompting information, content of said prompting information is determined for every said group.

[Additional Statement 29]

The comment-prompting method according to Additional statement 28, further comprising

a step to acquire a correspondence relation between each said group and a prescribed message,

wherein

in a step to present said prompting information, selects said message corresponding to said group to which said subject user belongs as said prompting information from among each of messages in acquired said correspondence relation.

[Additional Statement 30]

The comment-prompting method according to any of Additional statements 19 to 29, wherein

in a step to present said prompting information, a presenting method of said prompting information is determined for every said group.

[Additional Statement 31]

The comment-prompting method according to Additional statement 30, wherein

in a step to present said prompting information, a presenting timing of said prompting information is determined for every said group.

[Additional Statement 32]

The comment-prompting method according to Additional statement 30 or 31, further comprising

a step to acquire input record information indicating a record in which each user in a group to which said subject user belongs has inputted content of opinion with respect to one or more evaluation subjects,

wherein

in a step to present said prompting information, determines a presenting method of said prompting information based on acquired said input record information.

[Additional Statement 33]

The comment-prompting method according to any of Additional statements 19 to 32, wherein

in a step to present said prompting information, in the case where even if prescribed time has elapsed after a prescribed timing, a new evaluation subject or content of opinion with respect to said presented evaluation subject is not inputted, presented is said prompting information to said subject user.

[Additional Statement 34]

The comment-prompting method according to Additional statement 33, further comprising

a step to acquire standby time after said prescribed timing until each user starts inputting of content of opinion with respect to one or more evaluation subjects,

wherein

in a step to present said prompting information, calculated is said prescribed time based on said standby time of each user in said group to which said subject user belongs.

[Additional Statement 35]

The comment-prompting method according to Additional statement 34, wherein

in a step to present said prompting information, created is a frequency distribution of said standby time of each user in said group to which said subject user belongs, and calculated is said prescribed time based on a created frequency distribution.

[Additional Statement 36]

The comment-prompting method according to Additional statement 33, further comprising

a step to acquire input record information indicating a record in which each user has inputted content of opinion with respect to other evaluation subjects other than said presented evaluation subject,

wherein

in a step to acquire said user information, as said operation history, acquired is user information indicating a record in which said subject user has inputted content of opinion with respect to said other evaluation subjects, and

in a step to determine said group, users are classified into a plurality of groups based on acquired said input record information, and determined is a group to which said subject user belongs from among said two or more groups based on acquired said user information, and

in a step to present said prompting information, calculated is said prescribed time based on said group to which said subject user belongs.

[Additional Statement 37]

A computer readable recording medium in which recorded is a comment-prompting program to make a computer execute:

a step to acquire user information indicating at least one of an attribute of a subject user, said subject user's content of opinion with respect to one or more evaluation subjects, and said subject user's operation history;

a step to determine a group to which said subject user belongs from among a plurality of groups based on said user information; and

a step to present, to said subject user, based on said group to which said subject user belongs, prompting information for inducing said subject user to input a new evaluation subject or content of opinion with respect to a presented evaluation subject which is an evaluation subject presented to said subject user.

[Additional Statement 38]

The computer readable recording medium according to Additional statement 37, wherein

an operation until said subject user inputs a new evaluation subject or content of opinion with respect to said presented evaluation subject is classified into a plurality of stages, and

in a step to acquire said user information, acquired is user information indicating said subject user's operation history in each said stage.

[Additional Statement 39]

The computer readable recording medium according to Additional statement 37 or 38, wherein

an operation until said subject user inputs a new evaluation subject or content of opinion with respect to said presented evaluation subject is classified into a plurality of stages, and

in a step to acquire said user information, acquired is user information indicating a move history of said stage by said subject user.

[Additional Statement 40]

The computer readable recording medium according to Additional statement 38 or 39, wherein

in a step to determine said group, based on at least either of said subject user's operation history in one or more said stages to which said subject user has moved before a subject stage and/or a move history of said stages by said subject user up to said subject stage, determined is a group to which said subject user belongs from among a plurality of groups, and

in a step to present said prompting information, in said subject stage or said stage to which said subject user moves after said subject stage, presented is said prompting information to said subject user based on said group to which said subject user belongs.

[Additional Statement 41]

The computer readable recording medium according to any of Additional statements 37 to 40, wherein

an operation until said subject user inputs a new evaluation subject or content of opinion with respect to said presented evaluation subject is classified into a plurality of stages, and

in a step to present said prompting information, for every said stage, presented is said prompting information for inducing said subject user to a next stage based on said group to which said subject user belongs.

[Additional Statement 42]

The computer readable recording medium according to any of Additional statements 38 to 41, wherein

said two or more stages include at least any two of: a stage where said subject user browses said presented evaluation subject; a stage where said subject user browses each user's content of opinion with respect to said presented evaluation subject; a stage where said subject user evaluates said presented evaluation subject; a stage where said subject user inputs content of opinion with respect to said presented evaluation subject; and a stage where said subject user inputs a new evaluation subject.

[Additional Statement 43]

The computer readable recording medium according to Additional statement 42, wherein

said two or more stages include at least a stage where said subject user browses said presented evaluation subject in a short time and a stage where said subject user browses it in a long time, or include at least a stage where said subject user browses each user's content of opinion with respect to said presented evaluation subject in a short time and a stage where said subject user browses it in a long time, and

in a step to present said prompting information, presented is said prompting information for purpose of inducing said subject user from a stage where said subject user browses said presented evaluation subject or said content of opinion in a short time to a stage where said subject user browses said presented evaluation subject or said content of opinion in a long time.

[Additional Statement 44]

The computer readable recording medium according to any of Additional statements 38 to 43, wherein

in a step to present said prompting information, in the case where even if prescribed time has elapsed after said subject user has moved to a certain said stage, said subject user does not move to a new said stage, presented is said prompting information to said subject user.

[Additional Statement 45]

The computer readable recording medium according to any of Additional statements 37 to 44, said comment-prompting program being a program to make a computer further execute:

a step to acquire classification information indicating a plurality of groups classified based on at least one of a user's content of opinion with respect to an evaluation subject, a user's operation history, and a user's attribute,

wherein

in a step to determine said group, based on acquired said user information, determines a group to which said subject user belongs from among said two or more groups indicated by acquired said classification information.

[Additional Statement 46]

The computer readable recording medium according to any of Additional statements 37 to 45, wherein

in a step to present said prompting information, content of said prompting information is determined for every said group.

[Additional Statement 47]

The computer readable recording medium according to Additional statement 46, said comment-prompting program being a program to make a computer further execute:

a step to acquire a correspondence relation between each said group and a prescribed message,

wherein

in a step to present said prompting information, selects said message corresponding to said group to which said subject user belongs as said prompting information from among each of messages in acquired said correspondence relation.

[Additional Statement 48]

The computer readable recording medium according to any of Additional statements 37 to 47, wherein

in a step to present said prompting information, a presenting method of said prompting information is determined for every said group.

[Additional Statement 49]

The computer readable recording medium according to Additional statement 48, wherein

in a step to present said prompting information, a presenting timing of said prompting information is determined for every said group.

[Additional Statement 50]

The computer readable recording medium according to Additional statement 48 or 49, said comment-prompting program being a program to make a computer further execute:

a step to acquire input record information indicating a record in which each user in a group to which said subject user belongs has inputted content of opinion with respect to one or more evaluation subjects,

wherein

in a step to present said prompting information, determines a presenting method of said prompting information based on acquired said input record information.

[Additional Statement 51]

The computer readable recording medium according to any of Additional statements 37 to 50, wherein

in a step to present said prompting information, in the case where even if prescribed time has elapsed after a prescribed timing, a new evaluation subject or content of opinion with respect to said presented evaluation subject is not inputted, presented is said prompting information to said subject user.

[Additional Statement 52]

The computer readable recording medium according to Additional statement 51, said comment-prompting program being a program to make a computer further execute:

a step to acquire standby time after said prescribed timing until each user starts inputting of content of opinion with respect to one or more evaluation subjects,

wherein

in a step to present said prompting information, calculated is said prescribed time based on said standby time of each user in said group to which said subject user belongs.

[Additional Statement 53]

The computer readable recording medium according to Additional statement 52, wherein

in a step to present said prompting information, created is a frequency distribution of said standby time of each user in said group to which said subject user belongs, and calculated is said prescribed time based on a created frequency distribution.

[Additional Statement 54]

The computer readable recording medium according to Additional statement 51, said comment-prompting program being a program to make a computer further execute:

a step to acquire input record information indicating a record in which each user has inputted content of opinion with respect to other evaluation subjects other than said presented evaluation subject,

wherein

in a step to acquire said user information, as said operation history, acquired is user information indicating a record in which said subject user has inputted content of opinion with respect to said other evaluation subjects, and

in a step to determine said group, users are classified into a plurality of groups based on acquired said input record information, and determined is a group to which said subject user belongs from among said two or more groups based on acquired said user information, and

in a step to present said prompting information, calculated is said prescribed time based on said group to which said subject user belongs.

Above-mentioned embodiments should be considered to an exemplification at all points, and not restrictive. The scope of the present invention is shown not by descriptions mentioned above but by the scope of the claims, and all modifications within meaning and scope equivalent to the claims are intended to be included therein.

This application claims priority on the basis of Japanese Patent Application No. 2010-238243 applied on Oct. 25, 2010, and takes in here all the disclosures thereof.

### INDUSTRIAL APPLICABILITY

According to the present invention, in a system for the purpose of collecting opinions with respect to a certain content, it is possible to induce a large number of users' comments. Therefore, the present invention has industrial applicability.

### DESCRIPTION OF SYMBOLS

1 Input Record Information Acquisition Part
2 Input Record Information Storage Part
3 User Information Acquisition Part
4 Group Determination Part
5 Input-Prompting Part
6 Phase Determination Part
7 User Information Storage Part
8 Prompting Information Storage Part
9 Classification Information Storage Part
101 Cpu
102 Main Memory
103 Hard Disk
104 Input Interface
105 Display Controller
106 Data Reader/Writer
107 Communication Interface
108 Keyboard
109 Mouse
110 Display
111 Recording Medium
121 Bus
201 Information-Processing Device

What is claimed is:

1. An information-processing device, comprising:
a user information acquisition part configured to acquire user information indicating at least one of an attribute of a subject user, said subject user's content of opinion with respect to one or more evaluation subjects, and said subject user's operation history;
a group determination part configured to determine a group to which said subject user belongs from among a plurality of groups based on user information acquired by said user information acquisition part; and
an input-prompting part configured to present, to said subject user based on said group to which said subject user belongs, prompting information for inducing said subject user to input a new evaluation subject or content of opinion with respect to a presented evaluation subject which is an evaluation subject presented to said subject user.

2. The information-processing device according to claim 1, wherein
an operation until said subject user inputs a new evaluation subject or content of opinion with respect to said presented evaluation subject is classified into a plurality of stages, and
said user information acquisition part acquires user information indicating said subject user's operation history in each said stage.

3. The information-processing device according to claim 1, wherein
an operation until said subject user inputs a new evaluation subject or content of opinion with respect to said presented evaluation subject is classified into a plurality of stages, and
said user information acquisition part acquires user information indicating a move history of said stage by said subject user.

4. The information-processing device according to claim 2, wherein
said group determination part, based on at least either of said subject user's operation history in one or more said stages to which said subject user has moved before a subject stage and/or a move history of said stages by said subject user up to said subject stage, determines a group to which said subject user belongs from among a plurality of groups, and
said input-prompting part, in said subject stage or said stage to which said subject user moves after said subject stage, presents said prompting information to said subject user based on said group to which said subject user belongs.

5. The information-processing device according to claim 1, wherein
an operation until said subject user inputs a new evaluation subject or content of opinion with respect to said presented evaluation subject is classified into a plurality of stages, and
said input-prompting part, for every said stage, based on said group to which said subject user belongs, presents said prompting information for inducing said subject user to a next stage.

6. The information-processing device according to claim 2 wherein
said two or more stages include at least any two of: a stage where said subject user browses said presented evaluation subject; a stage where said subject user browses each user's content of opinion with respect to said presented evaluation subject; a stage where said subject user evaluates said presented evaluation subject; a stage where said subject user inputs content of opinion with respect to said presented evaluation subject; and a stage where said subject user inputs a new evaluation subject.

7. The information-processing device according to claim 6, wherein
said two or more stages include at least a stage where said subject user browses said presented evaluation subject in a short time and a stage where said subject user browses it in a long time, or include at least a stage where said subject user browses each user's content of opinion with respect to said presented evaluation subject in a short time and a stage where said subject user browses it in a long time, and
said input-prompting part presents said prompting information for purpose of inducing said subject user from a stage where said subject user browses said presented evaluation subject or said content of opinion in a short time to a stage where said subject user browses said presented evaluation subject or said content of opinion in a long time.

8. The information-processing device according to claim 2, wherein
said input-prompting part, in the case where even if prescribed time has elapsed after said subject user has moved to a certain said stage, said subject user does not move to a new said stage, presents said prompting information to said subject user.

9. The information-processing device according to claim 1, further comprising
a classification information storage part configured to store classification information indicating a plurality of groups classified based on at least one of a user's content of opinion with respect to an evaluation subject, a user's operation history, and a user's attribute, wherein
said group determination part, based on user information acquired by said user information acquisition part, determines a group to which said subject user belongs from among said two or more groups indicated by said classification information.

10. The information-processing device according to claim 1, wherein
said input-prompting part determines content of said prompting information for every said group.

11. The information-processing device according to claim 10, further comprising
a message storage part configured to store a correspondence relation between each said group and a prescribed message,
wherein
said input-prompting part, from among said messages stored by said message storage part, selects said message corresponding to said group to which said subject user belongs as said prompting information.

12. The information-processing device according to claim 1, wherein
said input-prompting part determines a presenting method of said prompting information for every said group.

13. The information-processing device according to claim 12, wherein
said input-prompting part determines a presenting timing of said prompting information for every said group.

14. The information-processing device according to claim 12, further comprising
an input record information acquisition part configured to acquire input record information indicating a record in which each user in a group to which said subject user belongs has inputted content of opinion with respect to one or more evaluation subjects,
wherein
said input-prompting part, based on said input record information acquired by said input record information acquisition part, determines a presenting method of said prompting information.

15. The information-processing device according to claim 1, wherein
said input-prompting part, in the case where even if prescribed time has elapsed after a prescribed timing, a new evaluation subject or content of opinion with respect to said presented evaluation subject is not inputted, presents said prompting information to said subject user.

16. The information-processing device according to claim 15, further comprising
an input record information acquisition part configured to acquire standby time after said prescribed timing until each user starts inputting of content of opinion with respect to one or more evaluation subjects, wherein
said input-prompting part, based on said standby time of each user in said group to which said subject user belongs, calculates said prescribed time.

17. The information-processing device according to claim 16, wherein
said input-prompting part creates a frequency distribution of said standby time of each user in said group to which said subject user belongs, and calculates said prescribed time based on a created frequency distribution.

18. The information-processing device according to claim 15, further comprising
an input record information acquisition part configured to acquire input record information indicating a record in which each user has inputted content of opinion with respect to other evaluation subjects other than said presented evaluation subject,
wherein
said user information acquisition part, as said operation history, acquires user information indicating a record in which said subject user has inputted content of opinion with respect to said other evaluation subjects, and
said group determination part classifies users into a plurality of groups based on said input record information acquired by said input record information acquisition part, and based on said user information acquired by said user information acquisition part, determines a group to which said subject user belongs from among said two or more groups, and
said input-prompting part calculates said prescribed time based on said group to which said subject user belongs.

19. A comment-prompting method comprising:
a step to acquire user information indicating at least one of an attribute of a subject user, said subject user's content of opinion with respect to one or more evaluation subjects, and said subject user's operation history;
a step to determine a group to which said subject user belongs from among a plurality of groups based on said user information; and
a step to present, to said subject user, based on said group to which said subject user belongs, prompting information for inducing said subject user to input a new evaluation subject or content of opinion with respect to a presented evaluation subject which is an evaluation subject presented to said subject user.

20. A computer readable recording medium in which recorded is a comment-prompting program to make a computer execute:
a step to acquire user information indicating at least one of an attribute of a subject user, said subject user's content of opinion with respect to one or more evaluation subjects, and said subject user's operation history;
a step to determine a group to which said subject user belongs from among a plurality of groups based on said user information; and
a step to present, to said subject user, based on said group to which said subject user belongs, prompting information for inducing said subject user to input a new evaluation subject or content of opinion with respect to a presented evaluation subject which is an evaluation subject presented to said subject user.

21. The information-processing device according to claim 3, wherein
said group determination part, based on at least either of said subject user's operation history in one or more said stages to which said subject user has moved before a subject stage and/or a move history of said stages by said subject user up to said subject stage, determines a group to which said subject user belongs from among a plurality of groups, and
said input-prompting part, in said subject stage or said stage to which said subject user moves after said subject stage, presents said prompting information to said subject user based on said group to which said subject user belongs.

22. The information-processing device according to claim 3, wherein
said two or more stages include at least any two of: a stage where said subject user browses said presented evaluation subject; a stage where said subject user browses each user's content of opinion with respect to said presented evaluation subject; a stage where said subject user evaluates said presented evaluation subject; a stage where said subject user inputs content of opinion with respect to said presented evaluation subject; and a stage where said subject user inputs a new evaluation subject.

23. The information-processing device according to claim 3, wherein
said input-prompting part, in the case where even if prescribed time has elapsed after said subject user has moved to a certain said stage, said subject user does not move to a new said stage, presents said prompting information to said subject user.
